(19) United States
(12) Patent Application Publication
(10) Pub. No.: US 2022/0279566 A1
(43) Pub. Date: Sep. 1, 2022

(54) METHOD AND DEVICE IN NODES USED FOR WIRELESS COMMUNICATION

(71) Applicants: Yang HU, SHANGHAI (CN); Xiaobo ZHANG, SHANGHAI (CN)

(72) Inventors: Yang HU, SHANGHAI (CN); Xiaobo ZHANG, SHANGHAI (CN)

(73) Assignee: SHANGHAI TUILUO COMMUNICATION TECHNOLOGY PARTNERSHIP (LIMITED PARTNERSHIP), SHANGHAI (CN)

(21) Appl. No.: 17/679,132

(22) Filed: Feb. 24, 2022

(30) Foreign Application Priority Data
Feb. 26, 2021 (CN) 202110218064.9
Dec. 28, 2021 (CN) 202111623124.1

(51) Int. Cl. H04W 72/12; H04L 1/18

(52) U.S. Cl. CPC H04W 72/1289; H04L 1/1812; H04L 1/1861

(57) ABSTRACT

The present disclosure provides a method and a device in a node for wireless communications. A first receiver receives first DCI; and a first transmitter transmits a first signal, the first signal carrying a first HARQ-ACK bit sequence; herein, the first DCI comprises a first field; for the first DCI, the first field comprised is used for indicating a total number of cells scheduled by first-type DCI(s) and by the second-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the TB-based PDSCH receptions scheduled by the first-type DCI is greater than K, K being a positive integer; the second-type DCI is used for scheduling CBG-based PDSCH receptions.

### CROSS REFERENCE TO RELATED APPLICATIONS

This application claims the priority benefit of Chinese Patent Application No. 202110218064.9, filed on Feb. 26, 2021, and the priority benefit of Chinese Patent Application No. 202111623124.1, filed on Dec. 28, 2021, the full disclosure of which is incorporated herein by reference.

### BACKGROUND

### Technical Field

The present disclosure relates to transmission methods and devices in wireless communication systems, and in particular to a method and device for radio signal transmission in a wireless communication system supporting cellular networks.

### Related Art

In a 5G NR system, for the purpose of supporting wireless communications on higher-frequency bands (e.g., ranging from 52.6 GHz to 71 GHz), the 3GPP considers providing support in the NR Release 17 for a scheduling method in which a Downlink Control Information (DCI) signaling schedules multiple Physical Downlink Shared CHannel receptions (PDSCH receptions).

### SUMMARY

After introduction of the functionality of using one DCI for scheduling multiple PDSCH receptions, how to adjust the usage of a Downlink Assignment Index (DAI) reasonably to determine a Hybrid Automatic Repeat reQuest ACKnowledgement (HARQ-ACK) Codebook becomes a key issue that has to be addressed.

To address the above problem, the present disclosure provides a solution. In the statement above, the scenario in which a single DCI scheduling multiple PDSCHs is adopted has been presented for example; the present disclosure is also applicable to communications on different bands, transmission scenarios like single-TRP, Internet of Things (IoT), Multicast and Broadcast Services (MBS), V2X, non-terrestrial networks (NTN), Ultra Reliable and Low Latency Communication (URLLC) and Extended Reality (XR), where similar technical effects can be achieved. Additionally, the adoption of a unified solution for various scenarios, including but not limited to single DCI for scheduling multiple PDSCHs, communications on various frequency bands, IoT, MBS, V2X, NTN, URLLC, or XR, contributes to the reduction of hardcore complexity and costs. It should be noted that if no conflict is incurred, embodiments in a User Equipment (UE) in the present disclosure and the characteristics of the embodiments are also applicable to a base station, and vice versa. What's more, the embodiments in the present disclosure and the characteristics in the embodiments can be arbitrarily combined if there is no conflict.

In one embodiment, interpretations of the terminology in the present disclosure refer to definitions given in the 3GPP TS36 series.

In one embodiment, interpretations of the terminology in the present disclosure refer to definitions given in the 3GPP TS38 series.

In one embodiment, interpretations of the terminology in the present disclosure refer to definitions given in the 3GPP TS37 series.

In one embodiment, interpretations of the terminology in the present disclosure refer to definitions given in Institute of Electrical and Electronics Engineers (IEEE) protocol specifications.

The present disclosure provides a method in a first node for wireless communications, comprising:

receiving first DCI; and

transmitting a first signal, the first signal carrying a first HARQ-ACK bit sequence;

herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by (a) TB-based PDSCH reception(s) scheduled by a DCI is no greater than K: the DCI does not belong to the first-type DCI.

In one embodiment, a problem to be solved in the present disclosure includes: how to reasonably analyze the first field.

In one embodiment, a problem to be solved in the present disclosure includes: how to analyze a DAI field (or, total DAI field) comprised in DCI after introducing the function using a DCI for scheduling multiple PDSCH receptions.

In one embodiment, a problem to be solved in the present disclosure includes: how to determine a HARQ-ACK codebook after introducing the function using a DCI for scheduling multiple PDSCH receptions.

In one embodiment, a problem to be solved in the present disclosure includes: how to analyze a DAI field (or, total DAI field) comprised in a DCI when the number of Transport Blocks (TBs) scheduled by the DCI is greater than K.

In one embodiment, a problem to be solved in the present disclosure includes: how to determine a HARQ-ACK codebook associated with a DCI when the number of Transport Blocks (TBs) scheduled by the DCI is greater than K.

In one embodiment, characteristics of the above method include: a DAI field comprised in a DCI scheduling a TB-based PDSCH reception by which the number of TB(s) carried is greater than K and a DAI field comprised in a DCI scheduling a TB-based PDSCH reception by which the number of TB(s) carried is no greater than K are respectively used for different HARQ-ACK sub-codebooks.

In one embodiment, an advantage of the above method is that adjustments are made reasonably to the way of interpreting the DAI field, leading to advantages in two aspects: the DAI field bit overhead and the HARQ-ACK feedback overhead.

In one embodiment, an advantage of the above method is to avoid unnecessary HARQ-ACK feedback overhead without increasing bit overhead in a DAI field.

In one embodiment, an advantage of the above method is to avoid the increase in bit overhead of a DAI field.

In one embodiment, an advantage of the above method is to reduce the impact of missed DCI detections.

In one embodiment, an advantage of the above method is to support the communication method of using a DCI to schedule multiple PDSCH receptions.

According to one aspect of the present disclosure, the above method is characterized in that,

the first DCI belongs to the first-type DCI.

According to one aspect of the present disclosure, the above method is characterized in that,

the first HARQ-ACK bit sequence comprises (a) HARQ-ACK information bit(s) associated with the first DCI.

According to one aspect of the present disclosure, the above method is characterized in that,

K is equal to 1.

According to one aspect of the present disclosure, the above method is characterized in that,

the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

According to one aspect of the present disclosure, the above method is characterized in that,

the first signal is transmitted in a first time unit, each said first-type DCI indicates a HARQ-ACK information transmission in the first time unit.

According to one aspect of the present disclosure, the above method is characterized in that,

when a number of TB(s) carried by a TB-based PDSCH reception scheduled by a DCI is no greater than K: the DCI does not belong to the first-type DCI.

According to one aspect of the present disclosure, the above method is characterized in that,

the total number of the cell(s) scheduled by the first-type DCI(s) up to the current time interval in the first resource pool is: a total number of {serving cell, time interval}-pair(s) associated with first-type DCI(s) up to the current time interval.

According to one aspect of the present disclosure, the above method is characterized in that,

the total number of the cell(s) scheduled by the first-type DCI(s) up to the current time interval in the first resource pool is: a total number of {serving cell, time interval}-pair(s) being associated with the first-type DCI(s) in the first resource pool up to the current time interval.

According to one aspect of the present disclosure, the above method is characterized in that,

the total number of the cell(s) scheduled by the first-type DCI(s) up to the current time interval in the first resource pool is: a total number of {serving cell, time interval}-pair(s) being associated with the first-type DCI(s) in the first resource pool up to the current time interval according to a first ordering.

According to one aspect of the present disclosure, the above method is characterized in that,

a number of TB(s) carried by a TB-based PDSCH reception associated with a first time unit which is scheduled by the first-type DCI is greater than K.

In one embodiment, characteristics of the above method include: a DAI field comprised in a DCI scheduling a TB-based PDSCH reception associated with a first time unit, by which the number of TB(s) carried is greater than K and a DAI field comprised in a DCI scheduling a TB-based PDSCH reception associated with the first time unit, by which the number of TB(s) carried is no greater than K are respectively used for different HARQ-ACK sub-codebooks.

According to one aspect of the present disclosure, the above method is characterized in that,

a said first-type DCI is a DCI that fulfills either of two conditions: scheduling a TB based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, characteristics of the above method include: a DCI being used for scheduling a PDSCH reception based on TBs, the first DCI indicating the first time unit and also another time unit apart from it; whether the DCI is a said first-type DCI depends on a number of TB(s) carried by a TB based PDSCH reception associated with the first time unit that is scheduled by the DCI, whether the DCI is a said first-type DCI does not depend on a number of TB(s) carried by a TB-based PDSCH reception associated with the other time unit other than the first time unit that is scheduled by the DCI.

According to one aspect of the present disclosure, the above method is characterized in that,

some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

According to one aspect of the present disclosure, the above method is characterized in that,

the first signal is transmitted in a first time unit.

According to one aspect of the present disclosure, the above method is characterized in comprising:

receiving on M PDSCHs;

herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

According to one aspect of the present disclosure, the above method is characterized in that,

the first HARQ-ACK bit sequence comprises (a) HARQ-ACK information bit(s) associated with the first DCI.

According to one aspect of the present disclosure, the above method is characterized in that,

the value of the first field comprised in the first DCI is used to determine the first HARQ-ACK bit sequence.

In one embodiment, the multiple characters of the above method are optional.

In one embodiment, in case that no conflict is incurred, the multiple characters of the above method can be arbitrarily combined.

The present disclosure provides a method in a second node for wireless communications, comprising:

transmitting first DCI; and

receiving a first signal, the first signal carrying a first HARQ-ACK bit sequence;

herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by (a) TB-based PDSCH reception(s) scheduled by a DCI is no greater than K: the DCI does not belong to the first-type DCI.

According to one aspect of the present disclosure, the above method is characterized in that,

the first DCI belongs to the first-type DCI.

According to one aspect of the present disclosure, the above method is characterized in that,

the first HARQ-ACK bit sequence comprises (a) HARQ-ACK information bit(s) associated with the first DCI.

According to one aspect of the present disclosure, the above method is characterized in that,

K is equal to 1.

According to one aspect of the present disclosure, the above method is characterized in that,

the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

According to one aspect of the present disclosure, the above method is characterized in that,

the first signal is transmitted in a first time unit, each said first-type DCI indicates a HARQ-ACK information transmission in the first time unit.

According to one aspect of the present disclosure, the above method is characterized in that,

when a number of TB(s) carried by a TB-based PDSCH reception scheduled by a DCI is no greater than K: the DCI does not belong to the first-type DCI.

According to one aspect of the present disclosure, the above method is characterized in that,

the total number of the cell(s) scheduled by the first-type DCI(s) up to the current time interval in the first resource pool is: a total number of {serving cell, time interval}-pair(s) associated with first-type DCI(s) up to the current time interval.

According to one aspect of the present disclosure, the above method is characterized in that,

the total number of the cell(s) scheduled by the first-type DCI(s) up to the current time interval in the first resource pool is: a total number of {serving cell, time interval}-pair(s) being associated with the first-type DCI(s) in the first resource pool up to the current time interval.

According to one aspect of the present disclosure, the above method is characterized in that,

the total number of the cell(s) scheduled by the first-type DCI(s) up to the current time interval in the first resource pool is: a total number of {serving cell, time interval}-pair(s) being associated with the first-type DCI(s) in the first resource pool up to the current time interval according to a first ordering.

According to one aspect of the present disclosure, the above method is characterized in that,

a number of TB(s) carried by a TB-based PDSCH reception associated with a first time unit which is scheduled by the first-type DCI is greater than K.

According to one aspect of the present disclosure, the above method is characterized in that,

a said first-type DCI is a DCI that fulfills either of two conditions: scheduling a TB based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

According to one aspect of the present disclosure, the above method is characterized in that,

some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

According to one aspect of the present disclosure, the above method is characterized in that,

the first signal is transmitted in a first time unit.

According to one aspect of the present disclosure, the above method is characterized in comprising:

transmitting on M PDSCHs;

herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

According to one aspect of the present disclosure, the above method is characterized in that,

the first HARQ-ACK bit sequence comprises (a) HARQ-ACK information bit(s) associated with the first DCI.

According to one aspect of the present disclosure, the above method is characterized in that,

the value of the first field comprised in the first DCI is used to determine the first HARQ-ACK bit sequence.

In one embodiment, the multiple characters of the above method are optional.

In one embodiment, in case that no conflict is incurred, the multiple characters of the above method can be arbitrarily combined.

The present disclosure provides a first node for wireless communications, comprising:

a first receiver, receiving first DCI; and

a first transmitter, transmitting a first signal, the first signal carrying a first HARQ-ACK bit sequence;

herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by (a) TB-based PDSCH reception(s) scheduled by a DCI is no greater than K: the DCI does not belong to the first-type DCI.

According to one aspect of the present disclosure, the above device is characterized in that,

the first DCI belongs to the first-type DCI.

According to one aspect of the present disclosure, the above device is characterized in that,

the first HARQ-ACK bit sequence comprises (a) HARQ-ACK information bit(s) associated with the first DCI.

According to one aspect of the present disclosure, the above device is characterized in that,

K is equal to 1.

According to one aspect of the present disclosure, the above device is characterized in that,

the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

According to one aspect of the present disclosure, the above device is characterized in that,

the first signal is transmitted in a first time unit, each said first-type DCI indicates a HARQ-ACK information transmission in the first time unit.

According to one aspect of the present disclosure, the above device is characterized in that,

the total number of the cell(s) scheduled by the first-type DCI(s) up to the current time interval in the first resource pool is: a total number of {serving cell, time interval}-pair(s) associated with first-type DCI(s) up to the current time interval.

According to one aspect of the present disclosure, the above device is characterized in comprising:

the first receiver, receiving on M PDSCHs;

herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, when a number of TB(s) carried by a TB-based PDSCH reception scheduled by a DCI is no greater than K: the DCI does not belong to the first-type DCI.

In one embodiment, the total number of the cell(s) scheduled by the first-type DCI(s) up to the current time interval in the first resource pool is: a total number of {serving cell, time interval}-pair(s) associated with first-type DCI(s) up to the current time interval.

In one embodiment, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval.

In one embodiment, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval according to a first ordering.

In one embodiment, a number of TB(s) carried by a TB-based PDSCH reception associated with a first time unit which is scheduled by the first-type DCI is greater than K.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the first signal is transmitted in a first time unit.

In one embodiment, the first receiver receives on M PDSCHs; herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, the first HARQ-ACK bit sequence comprises (a) HARQ-ACK information bit(s) associated with the first DCI.

In one embodiment, the value of the first field comprised in the first DCI is used to determine the first HARQ-ACK bit sequence.

In one embodiment, in case that no conflict is incurred, the above characters of the above method can be arbitrarily combined.

The present disclosure provides a second node for wireless communications, comprising:

a second transmitter, transmitting first DCI; and

a second receiver, receiving a first signal, the first signal carrying a first HARQ-ACK bit sequence;

herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by (a) TB-based PDSCH reception(s) scheduled by a DCI is no greater than K: the DCI does not belong to the first-type DCI.

In one embodiment, the method in the present disclosure has the following advantages:
adjustments are made reasonably to the way of interpreting the DAI field, leading to advantages in two aspects: the DAI field bit overhead and the HARQ-ACK feedback overhead;
unnecessary HARQ-ACK feedback overhead can be avoided without increasing bit overhead in a DAI field;
an increase of DAI field bit overhead can be avoided;
it is beneficial to reduce the influence brought by the missed detection of DCI;
it is beneficial to support the communication using a DCI to schedule multiple PDSCH receptions;
being easily compatible;
increasing the flexibility of scheduling;
reducing the scheduling overhead.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of processing of a first node according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5 illustrates a flowchart of signal transmission according to one embodiment of the present disclosure.

FIG. 6 illustrates a flowchart of signal transmission according to one embodiment of the present disclosure.

FIG. 7 illustrates a flowchart of processing of a first node according to one embodiment of the present disclosure.

FIG. 8 illustrates a schematic diagram illustrating a total number of cells scheduled by first-type DCI and cells scheduled by second-type DCI up to a current time interval in a first resource pool according to one embodiment of the present disclosure.

FIG. 9 illustrates a schematic diagram of the relation between K and a number of TB(s) carried by TB-based PDSCH reception(s) associated with a first time unit scheduled by first-type DCI according to one embodiment of the present disclosure.

FIG. 10 illustrates a flowchart of processing of a first node on a third-type DCI according to one embodiment of the present disclosure.

FIG. 11 illustrates a flowchart of processing of a first node on a DCI according to one embodiment of the present disclosure.

FIG. 12 illustrates a schematic diagram of the relation between a first signal and a first time unit according to one embodiment of the present disclosure.

FIG. 13 illustrates a schematic diagram of the relation between first DCI and a second field according to one embodiment of the present disclosure.

FIG. 14 illustrates a schematic diagram of the relation between a first HARQ-ACK bit sequence and a first DCI according to one embodiment of the present disclosure.

FIG. 15 illustrates a schematic diagram of the relations among a first resource pool, a time interval and a first DCI according to one embodiment of the present disclosure.

FIG. 16 illustrates a structure block diagram of a processing device in a first node according to one embodiment of the present disclosure.

FIG. 17 illustrates a structure block diagram a processing device in a second node according to one embodiment of the present disclosure.

FIG. 18 illustrates a structure block diagram of a processing device in a first node according to one embodiment of the present disclosure.

FIG. 19 illustrates a structure block diagram a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

Embodiment 1 illustrates a flowchart of processing of a first node, as shown in FIG. 1.

In Embodiment 1, the first node in the present disclosure receives a first DCI in step 101; and transmits a first signal in step 102.

In Embodiment 1, the first signal carries a first HARQ-ACK bit sequence; the first DCI comprises a first field; for the first DCI, the first field comprised is used for indicating a total number of cell(s) scheduled by first-type DCI(s) and cell(s) scheduled by second-type DCI(s) up to a current time interval in a first resource pool, time-domain resources occupied by the first DCI belonging to the current time interval; the first-type DCI is used for scheduling a PDSCH reception based on Transport Blocks (TBs), and a number of TB(s) carried by the TB-based PDSCH reception scheduled by the first-type DCI is greater than K, K being a positive integer; the second-type DCI is used for scheduling a PDSCH reception based on Code Block Groups (CBG).

In one subembodiment of Embodiment 1, when a number of TB(s) carried by a TB-based PDSCH reception scheduled by a DCI is no greater than K: the DCI does not belong to the first-type DCI.

In one embodiment, the first signal comprises a radio signal.

In one embodiment, the first signal comprises a radio frequency signal.

In one embodiment, the first signal comprises a baseband signal.

In one embodiment, the phrase that the first signal carries a first HARQ-ACK bit sequence means: the first signal comprises an output by all or part of bits in the first HARQ-ACK bit sequence sequentially through some or all of CRC Insertion, Segmentation, Code Block (CB)-level CRC Insertion, Channel Coding, Rate Matching, Concatenation, Scrambling, Modulation, Layer Mapping, Precoding, Mapping to Resource Element, Multicarrier Symbol Generation, and Modulation and Upconversion.

In one embodiment, the DCI in the present disclosure refers to: DCI transmitted by the second node in the present disclosure targeting the first node in the present disclosure.

In one embodiment, the first signal is transmitted in a time unit.

In one embodiment, the first signal is transmitted in a time-frequency resource pool.

In one embodiment, transmission of the first signal occupies at least one Resource Element (RE).

In one embodiment, a said RE occupies a multicarrier symbol in time domain, and a subcarrier in frequency domain.

In one embodiment, the multicarrier symbol in the present disclosure is an Orthogonal Frequency Division Multiplexing (OFDM) Symbol.

In one embodiment, the multicarrier symbol in the present disclosure is a Single Carrier-Frequency Division Multiple Access (SC-FDMA) symbol.

In one embodiment, the multicarrier symbol in the present disclosure is a Discrete Fourier Transform Spread OFDM (DFT-S-OFDM) symbol.

In one embodiment, the first signal is transmitted on a Physical Uplink Control CHannel (PUCCH).

In one embodiment, the first signal is transmitted on a Physical Uplink Shared Channel (PUSCH).

In one embodiment, the first DCI is a DCI format 1_0, for the specific definition of the DCI format 1_0, refer to 3GPP TS38.212, Chapter 7.3.1.2.

In one embodiment, the first DCI is a DCI format 1_1, for the specific definition of the DCI format 1_1, refer to 3GPP TS38.212, Chapter 7.3.1.2.

In one embodiment, the first DCI is a DCI format 1_2, for the specific definition of the DCI format 1_2, refer to 3GPP TS38.212, Chapter 7.3.1.2.

In one embodiment, a said first-type DCI is a DCI format 1_0, for the specific definition of the DCI format 1_0, refer to 3GPP TS38.212, Chapter 7.3.1.2.

In one embodiment, a said first-type DCI is a DCI format 1_1, for the specific definition of the DCI format 1_1, refer to 3GPP TS38.212, Chapter 7.3.1.2.

In one embodiment, a said first-type DCI is a DCI format 1_2, for the specific definition of the DCI format 1_2, refer to 3GPP TS38.212, Chapter 7.3.1.2.

In one embodiment, a said second-type DCI is a DCI format 1_0, for the specific definition of the DCI format 1_0, refer to 3GPP TS38.212, Chapter 7.3.1.2.

In one embodiment, a said second-type DCI is a DCI format 1_1, for the specific definition of the DCI format 1_1, refer to 3GPP TS38.212, Chapter 7.3.1.2.

In one embodiment, a said second-type DCI is a DCI format 1_2, for the specific definition of the DCI format 1_2, refer to 3GPP TS38.212, Chapter 7.3.1.2.

In one embodiment, a said DCI in the present disclosure is transmitted in a PDCCH.

In one embodiment, a said DCI in the present disclosure is a Downlink Control Information (DCI) format.

In one embodiment, a said DCI in the present disclosure is a control signaling.

In one embodiment, a said DCI in the present disclosure is a L1 control signaling.

In one embodiment, a said DCI in the present disclosure is a physical layer control signaling.

In one embodiment, the first DCI is used to indicate Downlink Grant.

In one embodiment, a said first-type DCI is used to indicate Downlink Grant.

In one embodiment, a said second-type DCI is used to indicate Downlink Grant.

In one embodiment, the first field comprised is only for DCI associated with the first HARQ-ACK bit sequence.

In one embodiment, when the first HARQ-ACK bit sequence is comprised of one or more of HARQ-ACK bits indicating whether a PDSCH reception indicated by a piece of DCI is correctly received, where the DCI is a piece of DCI being associated with the first HARQ-ACK bit sequence.

In one embodiment, the first field comprised is only for the PDCCH monitoring occasion being associated with the first HARQ-ACK bit sequence.

In one embodiment, the first field comprised is only for the {reference cell, PDCCH monitoring occasion}-pair being associated with the first HARQ-ACK bit sequence.

In one embodiment, the first field comprised is only for a PDSCH being associated with the first HARQ-ACK bit sequence.

In one embodiment, the total number in the present disclosure is only limited to a total number determined in the first resource pool.

In one embodiment, transmission of a said DCI in the present disclosure occupies at least one RE.

In one embodiment, the first resource pool is configurable.

In one embodiment, the first resource pool is determined based on a pre-defined rule.

In one embodiment, a duration of a said time interval does not exceed 1 slot.

In one embodiment, a duration of a said time interval does not exceed 1 radio frame.

In one embodiment, a duration of a said time interval does not exceed 1 sub-frame.

In one embodiment, a duration of a said time interval is configurable.

In one embodiment, a said time interval is: a Physical Downlink Control CHannel (PDCCH) monitoring occasion.

In one embodiment, a said time interval comprises at least one multicarrier symbol.

In one embodiment, durations of two different said time intervals are the same or different.

In one embodiment, a said cell in the present disclosure is a serving cell.

In one embodiment, a cell scheduled by a piece of DCI in the present disclosure is a serving cell.

In one embodiment, cell(s) scheduled by a said first-type DCI is(are): cell(s) comprising frequency-domain resources occupied by a said TB-based PDSCH reception scheduled by a said first-type DCI.

In one embodiment, cell(s) scheduled by a said first-type DCI is(are): cell(s) comprising frequency-domain resources occupied by a said TB-based PDSCH reception scheduled by a said first-type DCI or occupied by the first-type DCI itself.

In one embodiment, cell(s) scheduled by a said first-type DCI is(are): cell(s) comprising frequency-domain resources occupied by the first-type DCI itself.

In one embodiment, cell(s) scheduled by a said first-type DCI is(are): cell(s) used for transmitting a said first-type DCI.

In one embodiment, cell(s) scheduled by a said second-type DCI is(are): cell(s) comprising frequency-domain resources occupied by a said CBG-based PDSCH reception scheduled by a said second-type DCI.

In one embodiment, cell(s) scheduled by a said second-type DCI is(are): cell(s) comprising frequency-domain resources occupied by a said CBG-based PDSCH reception scheduled by a said second-type DCI or occupied by the second-type DCI itself.

In one embodiment, cell(s) scheduled by a said second-type DCI is(are): cell(s) comprising frequency-domain resources occupied by the second-type DCI itself.

In one embodiment, cell(s) scheduled by a said second-type DCI is(are): cell(s) used for transmitting a said second-type DCI.

In one embodiment, the first HARQ-ACK bit sequence is transmitted on a physical layer channel, the first resource pool comprising a search space associated with the physical layer channel.

In one embodiment, the first HARQ-ACK bit sequence is transmitted on a physical layer channel, the first resource pool comprising a CCE associated with the physical layer channel.

In one embodiment, the first HARQ-ACK bit sequence is transmitted on a physical layer channel, the first resource pool comprising a PDCCH candidate associated with the physical layer channel.

In one embodiment, any said first-type DCI indicates HARQ-ACK information transmitted in a same physical layer channel.

In one embodiment, the physical layer channel is a PUCCH.

In one embodiment, the physical layer channel is a PUSCH.

In one embodiment, an index for a said current time interval is a PDCCH monitoring occasion index.

In one embodiment, the total number of cell(s) scheduled by the first-type DCI(s) and cell(s) scheduled by the second-type DCI(s) is: a total number of pieces of the first-type DCI and the second-type DCI.

In one embodiment, the number of cell(s) scheduled by a said first-type DCI is equal to 1.

In one embodiment, the number of cell(s) scheduled by a said second-type DCI is equal to 1.

In one embodiment, according to a predefined rule or a higher signaling configuration, for the first node:

the number of cell(s) scheduled by any DCI is equal to 1.

In one embodiment, no cell scheduled by the first DCI is configured with a CBG-based PDSCH reception.

In one embodiment, the K in the present disclosure is a positive integer.

In one embodiment, the K in the present disclosure is equal to 1 or 2.

In one embodiment, the K in the present disclosure is equal to 1.

In one embodiment, the K in the present disclosure is equal to 2.

In one embodiment, the K in the present disclosure is equal to 4.

In one embodiment, the K in the present disclosure is no greater than 8.

In one embodiment, the K in the present disclosure is no greater than 16.

In one embodiment, the K in the present disclosure is no greater than 1024.

In one embodiment, the K in the present disclosure is configured by a higher layer signaling.

In one embodiment, the K in the present disclosure is determined according to a higher layer signaling configuration.

In one embodiment, the K in the present disclosure is pre-defined.

In one embodiment, a said time interval in the present disclosure refers to: a PDCCH monitoring occasion.

In one embodiment, a said time interval in the present disclosure comprises at least one multicarrier symbol.

In one embodiment, a said time interval in the present disclosure comprises part of a slot.

In one embodiment, a said time interval in the present disclosure belongs to a time window (i.e., span).

In one embodiment, the first DCI is either a said first-type DCI or a said second-type DCI.

In one embodiment, the first DCI is a said first-type DCI.

In one embodiment, the first DCI is a said second-type DCI.

In one embodiment, time-domain resources occupied by a DCI belong to a said time interval.

In one embodiment, time-domain resources occupied by a DCI which indicates the first time unit in the present disclosure belong to a said time interval.

In one embodiment, the phrase of TB-based PDSCH reception refers to: one or more PDSCH receptions based on Transport Blocks.

In one embodiment, a PDSCH reception in the present disclosure carries one or more Transport Blocks (TBs).

In one embodiment, a Code Block Group (CBG)-based PDSCH reception carries one or more CBGs.

In one embodiment, the phrase that the first-type DCI is used to indicate TB-based PDSCH reception(s) comprises: any said first-type DCI is used to indicate one or more PDSCH receptions based on TBs.

In one embodiment, the phrase that the first-type DCI is used to indicate TB-based PDSCH reception(s) comprises: the first-type DCI is used to indicate multiple PDSCH receptions based on TBs.

In one embodiment, the phrase that the first-type DCI is used to indicate TB-based PDSCH reception(s) comprises: any said first-type DCI is used to indicate multiple PDSCH receptions based on TBs.

In one embodiment, for any said first-type DCI, a total number of TB(s) carried by one or more PDSCH receptions based on TBs indicated by the DCI is greater than K.

In one embodiment, for any said first-type DCI, a total number of TBs carried by multiple PDSCH receptions based on TBs indicated by the DCI is greater than K.

In one embodiment, the phrase that a number of TBs carried by the PDSCH reception(s) based on TBs indicated by the first-type DCI is greater than K comprises: the number of the PDSCH receptions based on TBs indicated by the first-type DCI being greater than K.

In one embodiment, for any said first-type DCI, the number of TBs carried by any of multiple PDSCH receptions based on TBs indicated by the DCI is equal to 1.

In one embodiment, the phrase that a number of TBs carried by PDSCH reception(s) based on TBs scheduled by the first-type DCI is greater than K comprises a meaning that: a total number of TBs carried by the TB-based PDSCH reception(s) scheduled by the first-type DCI is greater than K.

In one embodiment, the phrase of a number of TBs carried in the present disclosure refers to: a total number of TBs being carried.

In one embodiment, in domain, time-domain resources occupied by a said first-type DCI belong to a time interval comprised by the first resource pool in time domain.

In one embodiment, in domain, time-domain resources occupied by a said second-type DCI belong to a time interval comprised by the first resource pool in time domain.

In one embodiment, the first resource pool is a time-domain resource pool.

In one embodiment, in terms of time domain, the first resource pool comprises one or more said time intervals.

In one embodiment, the first resource pool is: a PDCCH monitoring occasion set.

In one embodiment, the first resource pool comprises one or more {serving cell, time interval}-pairs.

In one embodiment, the first resource pool comprises resources in two dimensions: time domain and frequency domain.

In one embodiment, the first resource pool is a time-frequency resource pool.

In one embodiment, in terms of time domain, the first resource pool is comprised of a positive integer number of multicarrier symbol(s).

In one embodiment, in terms of time domain, the first resource pool is comprised of a positive integer number of time interval(s).

In one embodiment, in terms of frequency domain, the first resource pool is comprised of a positive integer number of subcarrier(s).

In one embodiment, in terms of frequency domain, the first resource pool is comprised of a positive integer number of cell(s).

In one embodiment, a limited number of {serving cell, time interval}-pair(s) can be defined in the first resource pool.

In one embodiment, at least one {serving cell, time interval}-pair can be defined in the first resource pool.

In one embodiment, the first resource pool comprises resources occupied by a limited number of {serving cell, time interval}-pair(s).

In one embodiment, the first resource pool comprises resources occupied by at least one {serving cell, time interval}-pair.

In one embodiment, the first resource pool comprises time-domain resources occupied by at least one {serving cell, time interval}-pair.

In one embodiment, the time interval in the present disclosure is targeted at a specific time unit.

In one embodiment, the time interval in the present disclosure is targeted at a first time unit; the first DCI indicates the first time unit.

In one embodiment, each piece of the first-type DCI indicates a same time unit.

In one embodiment, each piece of the second-type DCI indicates a same time unit.

In one embodiment, the first-type DCI and the second-type DCI are both DCI indicating a same PUCCH in a same time unit.

In one embodiment, each piece of the first-type DCI indicates transmission of HARQ-ACK information in a same time unit.

In one embodiment, each piece of the second-type DCI indicates transmission of HARQ-ACK information in a same time unit.

In one embodiment, the first-type DCI and the second-type DCI are both DCI indicating HARQ-ACK information transmission in a same time unit.

In one embodiment, each piece of the first-type DCI indicates a first time unit.

In one embodiment, each piece of the second-type DCI indicates a first time unit.

In one embodiment, the first-type DCI and the second-type DCI are both DCI indicating a same PUCCH in a first time unit.

In one embodiment, each piece of the first-type DCI indicates transmission of HARQ-ACK information in a first time unit.

In one embodiment, each piece of the second-type DCI indicates transmission of HARQ-ACK information in a first time unit.

In one embodiment, the first-type DCI and the second-type DCI are both DCI indicating HARQ-ACK information transmission in a first time unit.

In one embodiment, in the present disclosure, a DCI indicating a time unit means that: the DCI indicates transmitting HARQ-ACK information in the time unit.

In one embodiment, in the present disclosure, a DCI indicating a time unit means that: a PDSCH-to-HARQ_feedback timing indicator field comprised in the DCI indicates the time unit.

In one embodiment, the time unit in the present disclosure refers to: a time unit used for transmitting HARQ-ACK information.

In one embodiment, the first-type DCI in the present disclosure is targeted at a specific time unit.

In one embodiment, the second-type DCI in the present disclosure is targeted at a specific time unit.

In one embodiment, the first-type DCI in the present disclosure is targeted at the first time unit.

In one embodiment, the second-type DCI in the present disclosure is targeted at the first time unit.

In one embodiment, according to a predefined rule or a higher signaling configuration, for the first node in the present disclosure: a number of TB(s) carried by any TB-based PDSCH reception is equal to 1.

In one embodiment, according to a predefined rule or a higher signaling configuration, for the first node in the present disclosure: when a number of TB-based PDSCH receptions scheduled by a DCI is greater than K0, a number of TB(s) carried by any PDSCH reception based on TBs scheduled by the DCI is equal to 1.

In one embodiment, K0 is equal to 1.

In one embodiment, K0 is equal to 2.

In one embodiment, K0 is a positive integer.

In one embodiment, K0 is no greater than 8.

In one embodiment, K0 is no greater than 16.

In one embodiment, K0 is no greater than 1024.

In one embodiment, K0 is the K in the present disclosure.

In one embodiment, K0 is the K1 in the present disclosure.

In one embodiment, the K0 is configured by a higher layer signaling.

In one embodiment, the K0 is determined according to a higher layer signaling configuration.

In one embodiment, the K0 is default.

In one embodiment, according to a predefined rule or a higher signaling configuration, for the first node in the present disclosure: a number of TB(s) carried by any TB-based PDSCH reception is no greater than 2.

In one embodiment, multiple PDSCH receptions based on TBs scheduled by a said first-type DCI are mutually non-overlapping in time domain.

In one embodiment, multiple PDSCH receptions based on TBs scheduled by a said first-type DCI respectively belong to different time units in time domain.

In one embodiment, a said PDSCH reception carries only one TB.

In one embodiment, a said PDSCH reception carries at most 2 TBs.

In one embodiment, when a DCI schedules a TB-based PDSCH reception: the DCI does not belong to the second-type DCI.

In one embodiment, when a number of TB(s) carried by a TB-based PDSCH reception indicated by a DCI is no greater than K: the DCI does not belong to the first-type DCI.

In one embodiment, when a number of TB(s) carried by a TB-based PDSCH reception scheduled by a DCI is no greater than K: the DCI does not belong to the second-type DCI.

In one embodiment, the first field comprised in the first DCI is unrelated to any DCI other than the first-type DCI or the second-type DCI.

In one embodiment, value of the first field comprised in the first DCI is unrelated to any DCI that is not one of the first-type DCI or the second-type DCI.

In one embodiment, the phrase that a number of TBs carried by PDSCH reception(s) based on TBs scheduled by the first-type DCI is greater than K comprises a meaning that: a number of TBs carried by a TB-based PDSCH reception associated with a first time unit which is scheduled by the first-type DCI is greater than K.

In one embodiment, the time-domain resources occupied by the first DCI comprises at least one multicarrier symbol.

In one embodiment, a said first-type DCI comprises one PUCCH resource indicator (PRI) field.

In one embodiment, a said first-type DCI comprises one or two PRI fields.

In one embodiment, the first field in the present disclosure is an indication field.

In one embodiment, the first field in the present disclosure is used for counting.

In one embodiment, the first field in the present disclosure is a Downlink Assignment Indicator (DAI) field.

In one embodiment, the first field in the present disclosure is a total DAI field.

In one embodiment, the first field in the present disclosure comprises 1 bit.

In one embodiment, the first field in the present disclosure comprises 2 bits.

In one embodiment, the first field in the present disclosure comprises 3 bits.

In one embodiment, the first field in the present disclosure comprises 4 bits.

In one embodiment, the first field in the present disclosure comprises no more than 32 bits.

In one embodiment, a value in the first field in the present disclosure is 1 or 2.

In one embodiment, a value in the first field in the present disclosure is one of 1, 2, 3 or 4.

In one embodiment, a value in the first field in the present disclosure is one of 1, 2, 3, 4, 5, 6, 7 or 8.

In one embodiment, a value in the first field in the present disclosure is one of 1, 2, 3, 4, 5, 6, 7, 8, 9, 10, 11, 12, 13, 14, 15 or 16.

In one embodiment, a value in the first field in the present disclosure is one of 0, 1, 2, or 3.

In one embodiment, a value in the first field in the present disclosure is one of 0 through 7.

In one embodiment, the first-type DCI in the present disclosure comprises the first field.

In one embodiment, the second-type DCI in the present disclosure comprises the first field.

In one embodiment, when a piece of DCI is used for indicating time-frequency resources occupied by a data channel on a cell, the DCI schedules the cell.

In one embodiment, when a piece of DCI is used for releasing time-frequency resources occupied by a data channel on a cell, the DCI schedules the cell.

In one embodiment, the data channel comprises a PDSCH.

In one embodiment, the data channel comprises a DL-SCH.

In one embodiment, the data channel comprises a PUSCH.

In one embodiment, the data channel comprises a UL-SCH.

In one embodiment, when a piece of DCI is used for configuring a Transmission Configuration Indicator (TCI) state on a cell, the DCI schedules the cell.

In one embodiment, when a piece of DCI is used for configuring a transmit (Tx) power on a cell, the DCI schedules the cell.

In one embodiment, the first field is used for determining whether there is any missed detection of DCI.

In one embodiment, each piece of the DCI in the present disclosure is a DCI indicating HARQ-ACK information transmitted in a same time unit.

In one embodiment, each piece of the DCI in the present disclosure is: a DCI indicating HARQ-ACK information transmitted in a first time unit.

### Embodiment 2

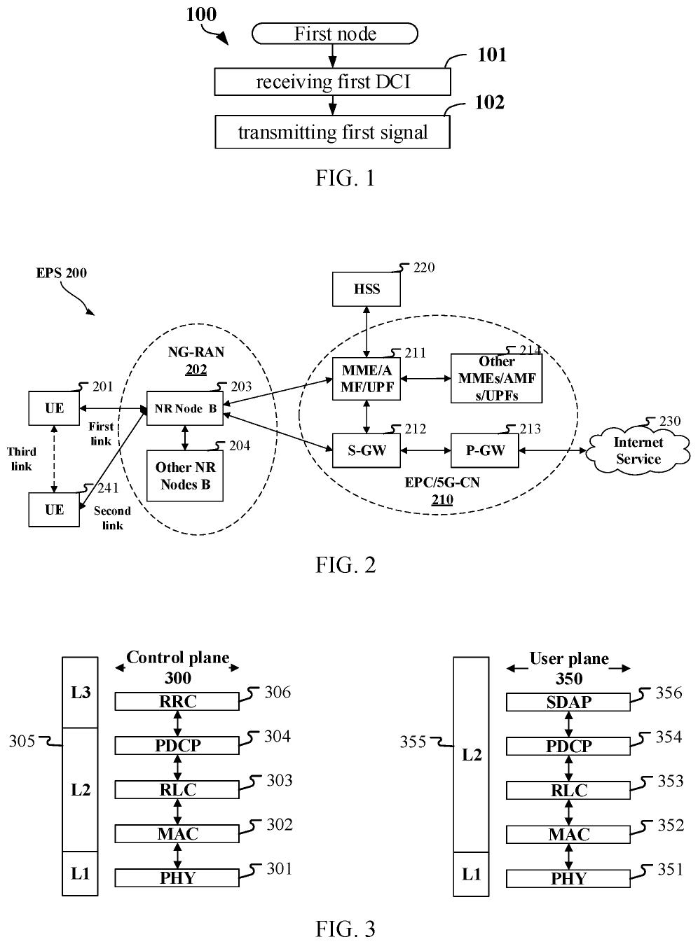

Embodiment 2 illustrates a schematic diagram of a network architecture according to the present disclosure, as shown in FIG. 2.

FIG. 2 is a diagram illustrating a network architecture 200 of 5G NR, Long-Term Evolution (LIE) and Long-Term Evolution Advanced (LIE-A) systems. The 5G NR or LIE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present disclosure can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present disclosure.

In one embodiment, the UE 241 corresponds to the second node in the present disclosure.

In one embodiment, the gNB 203 corresponds to the second node in the present disclosure.

In one embodiment, the UE 241 corresponds to the first node in the present disclosure.

In one embodiment, the UE 201 corresponds to the second node in the present disclosure.

### Embodiment 3

Embodiment 3 illustrates a schematic diagram of a radio protocol architecture of a user plane and a control plane according to the present disclosure, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first DCI in the present disclosure is generated by the PHY 301.

In one embodiment, the first DCI in the present disclosure is generated by the PHY 351.

In one embodiment, a DCI in the present disclosure is generated by the PHY 301.

In one embodiment, a DCI in the present disclosure is generated by the PHY 351.

In one embodiment, the first HARQ-ACK bit sequence in the present disclosure is generated by the MAC sublayer 302.

In one embodiment, the first HARQ-ACK bit sequence in the present disclosure is generated by the MAC sublayer 352.

In one embodiment, the first HARQ-ACK bit sequence in the present disclosure is generated by the PHY 301.

In one embodiment, the first HARQ-ACK bit sequence in the present disclosure is generated by the PHY 351.

In one embodiment, the first signal in the present disclosure is generated by the PHY 301.

In one embodiment, the first signal in the present disclosure is generated by the PHY 351.

### Embodiment 4

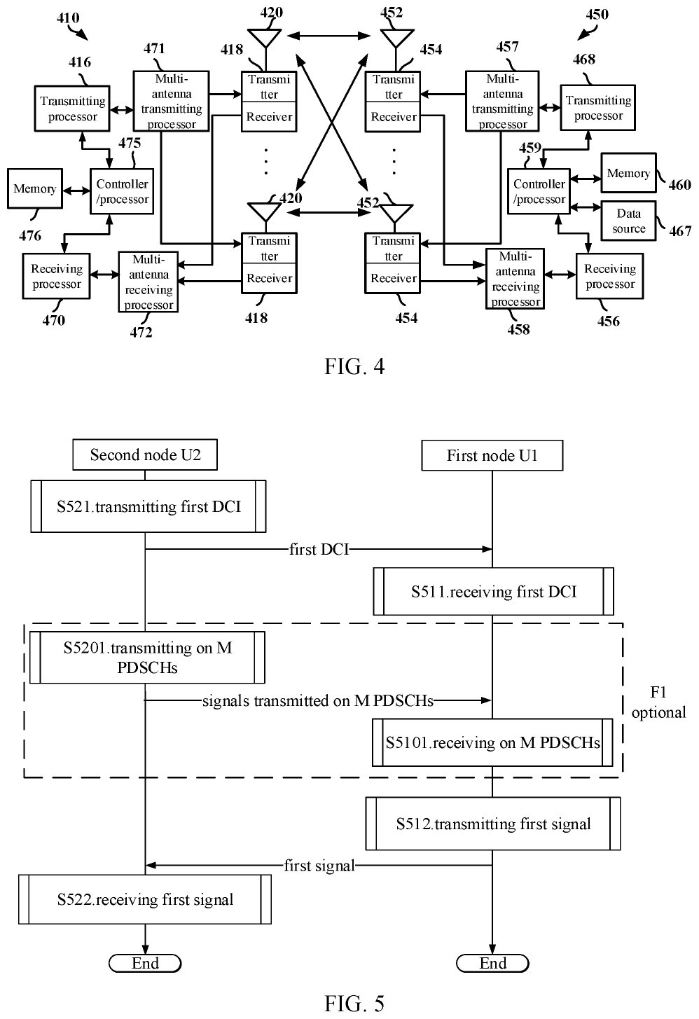

Embodiment 4 illustrates a schematic diagram of a first communication device and a second communication device according to the present disclosure, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present disclosure comprises the second communication device 450, and the second node in the present disclosure comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication node 450 comprises at least one processor and at least one memory, the at least one memory comprises computer program codes; the at least one memory and the computer program codes are configured to be used in collaboration with the at least one processor. the second communication node 450 at least receives the first DCI in the present disclosure; and transmits the first signal in the present disclosure, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) and cell(s) scheduled by second-type DCI(s) in the present disclosure up to a current time interval in the first resource pool in the present disclosure, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one subembodiment, the second communication device 450 corresponds to the first node in the present disclosure.

In one embodiment, the second communication node 450 comprises a memory that stores a computer readable instruction program, the computer readable instruction program generates actions when executed by at least one processor, which include: receiving the first DCI in the present disclosure; and transmitting the first signal in the present disclosure, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) and cell(s) scheduled by second-type DCI(s) in the present disclosure up to a current time interval in the first resource pool in the present disclosure, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one subembodiment, the second communication device 450 corresponds to the first node in the present disclosure.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits the first DCI in the present disclosure; and receives the first signal, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) and cell(s) scheduled by second-type DCI(s) in the present disclosure up to a current time interval in the first resource pool in the present disclosure, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one subembodiment, the first communication device 410 corresponds to the second node in the present disclosure.

In one embodiment, the first communication device 410 comprises a memory that stores a computer readable instruction program, the computer readable instruction program generates actions when executed by at least one processor, which include: transmitting the first DCI in the present disclosure; and receiving the first signal, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) and cell(s) scheduled by second-type DCI(s) in the present disclosure up to a current time interval in the first resource pool in the present disclosure, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one subembodiment, the first communication device 410 corresponds to the second node in the present disclosure.

In one embodiment, the second communication node 450 comprises at least one processor and at least one memory, the at least one memory comprises computer program codes; the at least one memory and the computer program codes are configured to be used in collaboration with the at least one processor. the second communication node 450 at least receives the first DCI in the present disclosure; and transmits the first signal in the present disclosure, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) in the present disclosure up to a current time interval in the first resource pool in the present disclosure, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one subembodiment, the second communication device 450 corresponds to the first node in the present disclosure.

In one embodiment, the second communication node 450 comprises a memory that stores a computer readable instruction program, the computer readable instruction program generates actions when executed by at least one processor, which include: receiving the first DCI in the present disclosure; and transmitting the first signal in the present disclosure, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) in the present disclosure up to a current time interval in the first resource pool in the present disclosure, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one subembodiment, the second communication device 450 corresponds to the first node in the present disclosure.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits the first DCI in the present disclosure; and receives the first signal, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) in the present disclosure up to a current time interval in the first resource pool in the present disclosure, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one subembodiment, the first communication device 410 corresponds to the second node in the present disclosure.

In one embodiment, the first communication device 410 comprises a memory that stores a computer readable instruction program, the computer readable instruction program generates actions when executed by at least one processor, which include: transmitting the first DCI in the present disclosure; and receiving the first signal, the first signal carrying the first HARQ-ACK bit sequence in the present disclosure; herein, the first DCI comprises the first field in the present disclosure; for the first DCI, the first field comprised is used for indicating a total number of cell(s) scheduled by first-type DCI(s) in the present disclosure up to a current time interval in the first resource pool in the present disclosure, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one subembodiment, the first communication device 410 corresponds to the second node in the present disclosure.

In one embodiment, at least one of the antenna 452, the receiver 454, the multi-antenna receiving processor 458, the receiving processor 456, the controller/processor 459, the memory 460, or the data source 467 is used for receiving the first DCI in the present disclosure.

In one embodiment, at least one of the antenna 420, the transmitter 418, the multi-antenna transmitting processor 471, the transmitting processor 416, the controller/processor 475 or the memory 476 is used for transmitting the first DCI in the present disclosure.

In one embodiment, at least one of the antenna 452, the receiver 454, the multi-antenna receiving processor 458, the receiving processor 456, the controller/processor 459, the memory 460, or the data source 467 is used for receiving a DCI in the present disclosure.

In one embodiment, at least one of the antenna 420, the transmitter 418, the multi-antenna transmitting processor 471, the transmitting processor 416, the controller/processor 475 or the memory 476 is used for transmitting a DCI in the present disclosure.

In one embodiment, at least one of the antenna 452, the receiver 454, the multi-antenna receiving processor 458, the receiving processor 456, the controller/processor 459, the memory 460, or the data source 467 is used for receiving on the M PDSCHs in the present disclosure.

In one embodiment, at least one of the antenna 420, the transmitter 418, the multi-antenna transmitting processor 471, the transmitting processor 416, the controller/processor 475 or the memory 476 is used for transmitting on the M PDSCHs in the present disclosure.

In one embodiment, at least one of the antenna 452, the transmitter 454, the multi-antenna transmitting processor 468, the controller/processor 459, the memory 460 or the data source 467 is used for transmitting the first signal in the present disclosure.

In one embodiment, at least one of the antenna 420, the receiver 418, the multi-antenna receiving processor 472, the receiving processor 470, the controller/processor 475, or the memory 476 is used for receiving the first signal in the present disclosure.

### Embodiment 5

Embodiment 5 illustrates a flowchart of signal transmission according to one embodiment of the present disclosure, as shown in FIG. 5. In FIG. 5, a first node U1 and a second node U2 are in communications via an air interface. In FIG. 5, steps marked by the dotted-line frame box F1 are optional. In case of no conflict, characters in multiple subembodiments of Embodiment 5 can be arbitrarily and mutually combined.

The first node U1 receives a first DCI in step S511; receives on M PDSCHs in step S5101; and transmits a first signal in step S512.

The second node U2 transmits a first DCI in step S521; transmits on M PDSCHs in step S5201; and receives a first signal in step S522.

In Embodiment 5, the first signal carries a first HARQ-ACK bit sequence; the first DCI comprises a first field; for the first DCI, the first field comprised is used for indicating a total number of cell(s) scheduled by first-type DCI(s) and cell(s) scheduled by second-type DCI(s) up to a current time interval in a first resource pool, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG); The first node U1 is configured with CBG-based PDSCH reception on at least one serving cell; the first HARQ-ACK bit sequence comprises (a) HARQ-ACK information bit(s) associated with the first DCI; the first signal is transmitted in a first time unit.

In one subembodiment of Embodiment 5, a number of TBs carried by a TB-based PDSCH reception associated with a first time unit which is scheduled by the first-type DCI is greater than K.

In one subembodiment of the Embodiment 5, the total number of the cells scheduled by the first-type DCI(s) and by the second-type DCI(s) in the first resource pool up to the current time interval is: a total number of {serving cell, time interval}-pair(s) associated with either of the first-type DCI(s) or the second-type DCI(s) up to the current time interval.

In one subembodiment of the Embodiment 5, the total number of the cells scheduled by the first-type DCI(s) and by the second-type DCI(s) in the first resource pool up to the current time interval is: a total number of {serving cell, time interval}-pair(s) associated with either of the first-type DCI(s) or the second-type DCI(s) up to the current time interval in a first resource pool.

In one subembodiment of Embodiment 5, a said first-type DCI is a DCI that fulfills either of two conditions: scheduling a TB-based PDSCH reception by which all TBs carried are associated with the first time unit; or, scheduling a TB-based PDSCH reception by which some of multiple TBs carried are associated with the first time unit, while others of the multiple TBs carried are associated with a time unit other than the first time unit.

In one subembodiment of Embodiment 5, some of multiple TBs carried by a TB-based PDSCH reception scheduled by the first DCI are associated with the first time unit, while others of the multiple TBs carried by the TB-based PDSCH reception scheduled by the first DCI are associated with a time unit other than the first time unit.

In one subembodiment of Embodiment 5, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one subembodiment of Embodiment 5, when a number of TB(s) carried by a TB-based PDSCH reception scheduled by a DCI is no greater than K: the DCI does not belong to the first-type DCI.

In one embodiment, the first node U1 is the first node in the present disclosure.

In one embodiment, the second node U2 is the second node in the present disclosure.

In one embodiment, the first node U1 is a UE.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, M is equal to K.

In one embodiment, M is no greater than K.

In one embodiment, K is linear with M.

In one embodiment, M is equal to 2.

In one embodiment, M is greater than 2.

In one embodiment, M is equal to 4.

In one embodiment, M is equal to 8.

In one embodiment, M is no greater than a parameter's value configured by a higher layer signaling.

In one embodiment, the higher layer in the present disclosure comprises an RRC layer.

In one embodiment, the higher layer in the present disclosure comprises a MAC CE layer.

In one embodiment, the higher layer in the present disclosure is an RRC layer.

In one embodiment, the higher layer in the present disclosure is a MAC CE layer.

In one embodiment, the configuration information in the present disclosure comprises: at least one of {time-domain resource configuration, frequency-domain resource configuration, TCI configuration, antenna port configuration}.

In one embodiment, the steps marked by the dotted-line box F1 in FIG. 5 exist.

In one embodiment, the steps marked by the dotted-line box F1 in FIG. 5 do not exist.

### Embodiment 6

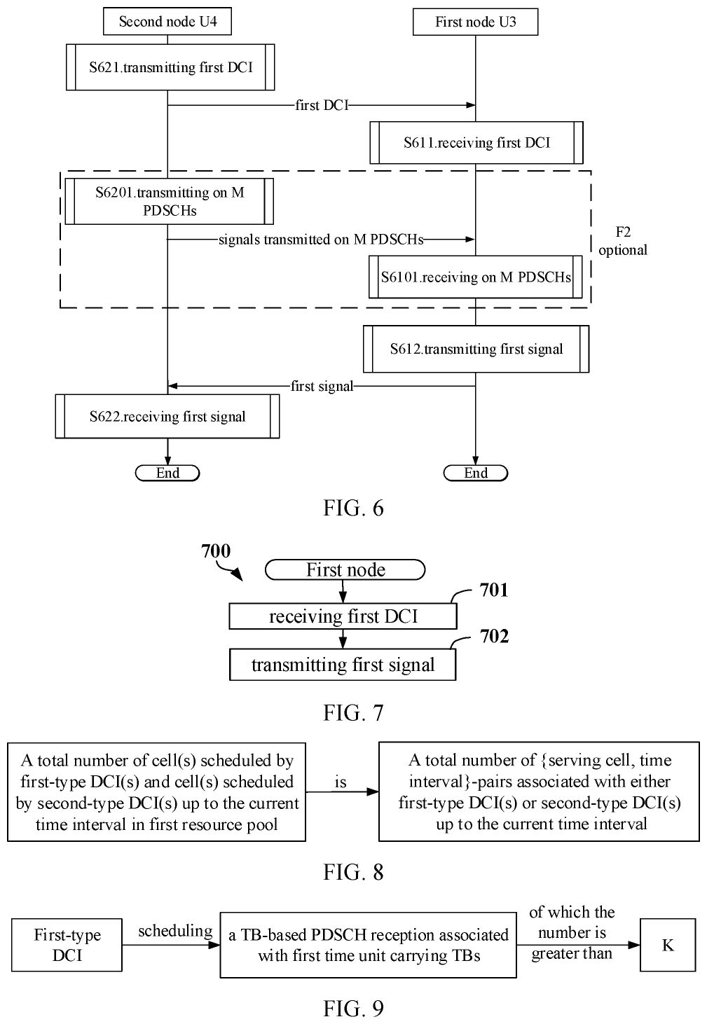

Embodiment 6 illustrates a flowchart of signal transmission according to one embodiment of the present disclosure, as shown in FIG. 6. In FIG. 6, a first node U3 and a second node U4 are in communications via an air interface. In FIG. 6, steps marked by the dotted-line frame box F2 are optional. In case of no conflict, characters in multiple subembodiments of Embodiment 6 can be arbitrarily and mutually combined.

The first node U3 receives a first DCI in step S611; receives on M PDSCHs in step S6101; and transmits a first signal in step S612.

The second node U4 transmits a first DCI in step S621; transmits on M PDSCHs in step S6201; and receives a first signal in step S622.

In Embodiment 6, the first signal carries a first HARQ-ACK bit sequence; the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; the first-type DCI is used for indicating a PDSCH reception based on Transport Blocks (TBs), and a number of TBs carried by the TB-based PDSCH reception indicated by the first-type DCI is greater than K, K being a positive integer; when a number of TB(s) carried by a TB-based PDSCH reception indicated by a DCI is no greater than K: the DCI does not belong to the first-type DCI; a number of TBs carried by a TB-based PDSCH reception associated with a first time unit which is scheduled by the first-type DCI is greater than K; the first signal is transmitted in the first time unit; the first HARQ-ACK bit sequence comprises (a) HARQ-ACK information bit(s) associated with the first DCI.

In one subembodiment of Embodiment 6, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one subembodiment of Embodiment 6, the value of the first field comprised in the first DCI is used to determine the first HARQ-ACK bit sequence.

In one subembodiment of Embodiment 6, the total number of the cell(s) scheduled by the first-type DCI(s) up to the current time interval in the first resource pool is: a total number of {serving cell, time interval}-pair(s) associated with first-type DCI(s) up to the current time interval.

In one subembodiment of Embodiment 6, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval.

In one subembodiment of Embodiment 6, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval according to a first ordering.

In one subembodiment of Embodiment 6, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one subembodiment of Embodiment 6, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the first node U3 is the first node in the present disclosure.

In one embodiment, the second node U4 is the second node in the present disclosure.

In one embodiment, the first node U3 is a UE.

In one embodiment, the second node U4 is a base station.

In one embodiment, the second node U4 is a UE.

In one embodiment, an air interface between the second node U4 and the first node U3 is a Uu interface.

In one embodiment, an air interface between the second node U4 and the first node U3 includes a cellular link.

In one embodiment, an air interface between the second node U4 and the first node U3 is a PC5 interface.

In one embodiment, an air interface between the second node U4 and the first node U3 includes a sidelink.

In one embodiment, an air interface between the second node U4 and the first node U3 includes a radio interface between a base station and a UE.

In one embodiment, the steps marked by the dotted-line box F2 in FIG. 6 exist.

In one embodiment, the steps marked by the dotted-line box F2 in FIG. 6 do not exist.

### Embodiment 7

Embodiment 7 illustrates a flowchart of processing of a first node according to the present disclosure, as shown in FIG. 7. In case of no conflict, the characters of multiple subembodiments of Embodiment 7 can be mutually combined.

In Embodiment 7, the first node in the present disclosure receives a first DCI in step 701; and transmits a first signal in step 702.

In Embodiment 7, the first signal carries a first HARQ-ACK bit sequence; the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; the first-type DCI is used for indicating a PDSCH reception based on Transport Blocks (TBs), and a number of TBs carried by the TB-based PDSCH reception indicated by the first-type DCI is greater than K, K being a positive integer.

In one subembodiment of Embodiment 7, when a number of TB(s) carried by a TB-based PDSCH reception indicated by a DCI is no greater than K: the DCI does not belong to the first-type DCI.

In one subembodiment of Embodiment 7, the total number of the cell(s) scheduled by the first-type DCI(s) up to the current time interval in the first resource pool is: a total number of {serving cell, time interval}-pair(s) associated with first-type DCI(s) up to the current time interval.

In one subembodiment of Embodiment 7, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval.

In one subembodiment of Embodiment 7, the total number of the cell(s) scheduled by the first-type DCI(s) up to the current time interval in the first resource pool is: a total number of {serving cell, time interval}-pair(s) being associated with the first-type DCI(s) in the first resource pool up to the current time interval according to a first ordering.

In one subembodiment of Embodiment 7, a number of TBs carried by a TB-based PDSCH reception associated with a first time unit which is scheduled by the first-type DCI is greater than K.

In one subembodiment of Embodiment 7, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one subembodiment of Embodiment 7, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one subembodiment of Embodiment 7, the first signal is transmitted in a first time unit.

In one subembodiment of Embodiment 7, the first HARQ-ACK bit sequence comprises (a) HARQ-ACK information bit(s) associated with the first DCI.

In one subembodiment of Embodiment 7, the value of the first field comprised in the first DCI is used to determine the first HARQ-ACK bit sequence.

### Embodiment 8

Embodiment 8 illustrates a schematic diagram illustrating a total number of cells scheduled by first-type DCI and cells scheduled by second-type DCI up to a current time interval in a first resource pool according to one embodiment of the present disclosure; as shown in FIG. 8.

In Embodiment 8, a total number of cells scheduled by first-type DCI and cells scheduled by second-type DCI up to a current time interval in a first resource pool is: a total number of {serving cell, time interval}-pains) associated with either of the first-type DCI(s) or the second-type DCI(s) up to the current time interval.

In one embodiment, the total number of the cells scheduled by the first-type DCI(s) and by the second-type DCI(s) in the first resource pool up to the current time interval is: a total number of {serving cell, time interval}-pains) associated with either of the first-type DCI(s) or the second-type DCI(s) up to the current time interval.

In one embodiment, the total number of the cells scheduled by the first-type DCI(s) and by the second-type DCI(s) in the first resource pool up to the current time interval is: a total number of {serving cell, time interval}-pains) associated with either of the first-type DCI(s) or the second-type DCI(s) up to the current time interval in the first resource pool.

In one embodiment, the total number of the cells scheduled by the first-type DCI(s) and by the second-type DCI(s) in the first resource pool up to the current time interval is: a total number of {serving cell, time interval}-pains) associated with the first-type DCI(s) and {serving cell, time interval}-pains) associated with the second-type DCI(s) up to the current time interval in the first resource pool.

In one embodiment, the total number of the cells scheduled by the first-type DCI(s) and by the second-type DCI(s) in the first resource pool up to the current time interval is: a total number of {serving cell, time interval}-pains) associated with either of the first-type DCI(s) or the second-type DCI(s) up to the current time interval in the first resource pool according to a first ordering.

In one embodiment, the total number of the cells scheduled by the first-type DCI(s) and by the second-type DCI(s) in the first resource pool up to the current time interval is: a total number of cells scheduled by first-type DCI and cells scheduled by second-type DCI up to the current time interval in the first resource pool.

In one embodiment, the first ordering refers to: an ascending order of start time(s) for search space set(s) associated with time interval(s).

In one embodiment, the first ordering refers to: an ascending order of indexes for time intervals.

In one embodiment, a number of {serving cell, time interval}-pair(s) associated with a DCI is equal to a number of cell(s) scheduled by the DCI.

In one embodiment, the serving cell in a {serving cell, time interval}-pair associated with a DCI is a cell scheduled by the DCI.

In one embodiment, a said {serving cell, time interval}-pair refers to: a {serving cell, PDCCH monitoring occasion}-pair.

### Embodiment 9

Embodiment 9 illustrates a schematic diagram of the relation between K and a number of TBs carried by TB-based PDSCH reception associated with a first time unit scheduled by first-type DCI according to one embodiment of the present disclosure, as shown in FIG. 9.

In Embodiment 9, a number of TBs carried by a TB-based PDSCH reception associated with a first time unit which is scheduled by the first-type DCI is greater than K.

In one embodiment, for a said first-type DCI: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, the first signal is transmitted in the first time unit.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, when a DCI is used for scheduling TB-based PDSCH reception, and when some of multiple TBs carried by the TB-based PDSCH reception scheduled by the DCI are associated with a first time unit while the others of the multiple TBs carried by the TB-based PDSCH reception scheduled are associated with a time unit other than the first time unit, besides, the number of TBs carried by the TB-based PDSCH reception associated with the first time unit which is scheduled by the DCI is greater than K: the DCI is a said first-type DCI.

In one embodiment, when a DCI is used for scheduling TB-based PDSCH reception, and when all of multiple TBs carried by the TB-based PDSCH reception scheduled by the DCI are associated with a first time unit, besides, the number of TBs carried by the TB-based PDSCH reception associated with the first time unit which is scheduled by the DCI is greater than K: the DCI is a said first-type DCI.

In one embodiment, the first DCI is a said first-type DCI; a total number of TBs carried by a TB-based PDSCH reception scheduled by the first DCI is greater than N, where N is a value configured by a higher layer signaling or a default one.

In one embodiment, when a total number of TB(s) carried by (a) TB-based PDSCH reception(s) scheduled by a DCI is greater than N: the DCI indicates feeding back various kinds of HARQ-ACK information in different time units.

In one embodiment, when a total number of TB(s) carried by (a) TB-based PDSCH reception(s) scheduled by a DCI is no greater than N: the DCI indicates feedback of HARQ-ACK information for all TBs carried by the PDSCH reception based on TBs scheduled by the DCI in a same time unit.

In one embodiment, the first DCI is a said first-type DCI, a number of TBs carried by a TB-based PDSCH reception associated with a first time unit which is scheduled by the first-type DCI is greater than K.

In one embodiment, the first DCI is a said first-type DCI; a total number of TB-based PDSCH receptions scheduled by the first DCI is greater than N, where N is a value configured by a higher layer signaling or a default one.

In one embodiment, when a total number of PDSCH receptions scheduled by a DCI is greater than N: the DCI indicates feeding back various kinds of HARQ-ACK information in different time units.

In one embodiment, when a total number of PDSCH receptions scheduled by a DCI is no greater than N: the DCI indicates feedback of all HARQ-ACK information for all PDSCH receptions scheduled by the DCI in a same time unit.

In one embodiment, both the first-type DCI and the second-type DCI indicate the first time unit.

In one embodiment, a DCI not indicating the first time unit belongs to neither the first-type DCI nor the second-type DCI.

In one embodiment, when a DCI is not used for scheduling a TB-based PDSCH reception: the DCI does not belong to the first-type DCI.

In one embodiment, when any TB carried by any TB-based PDSCH reception scheduled by a DCI is not associated with a first time unit: the DCI does not belong to the first-type DCI.

In one embodiment, when a number of TB(s) carried by a TB-based PDSCH reception associated with a first time unit which is scheduled by a DCI is no greater than K: the DCI does not belong to the first-type DCI.

In one embodiment, the second-type DCI is used for scheduling a PDSCH reception based on CBGs associated with a first time unit.

In one embodiment, in the present disclosure, a TB being associated with a time unit means that: a HARQ-ACK information bit generated for the TB is transmitted in the time unit.

In one embodiment, in the present disclosure, a TB being associated with a time unit means that: a PUCCH in the time unit is used for bearing a HARQ-ACK information bit generated for the TB.

In one embodiment, in the present disclosure, a TB being associated with a time unit means that: a DCI scheduling the TB indicates that a HARQ-ACK information bit generated for the TB is transmitted in the time unit.

In one embodiment, in the present disclosure, a PDSCH reception being associated with a time unit means that: a HARQ-ACK information bit generated for the PDSCH reception is transmitted in the time unit.

In one embodiment, in the present disclosure, a PDSCH reception being associated with a time unit means that: a PUCCH in the time unit is used for bearing a HARQ-ACK information bit generated for the PDSCH reception.

In one embodiment, in the present disclosure, a PDSCH reception being associated with a time unit means that: a DCI scheduling the PDSCH reception indicates that a HARQ-ACK information bit generated for the PDSCH reception is transmitted in the time unit.

In one embodiment, a TB carried by a PDSCH reception based on TBs which is associated with the first time unit is associated with the first time unit; in addition, the TB carried by the PDSCH reception based on TBs which is associated with the first time unit is carried by the TB-based PDSCH reception.

### Embodiment 10

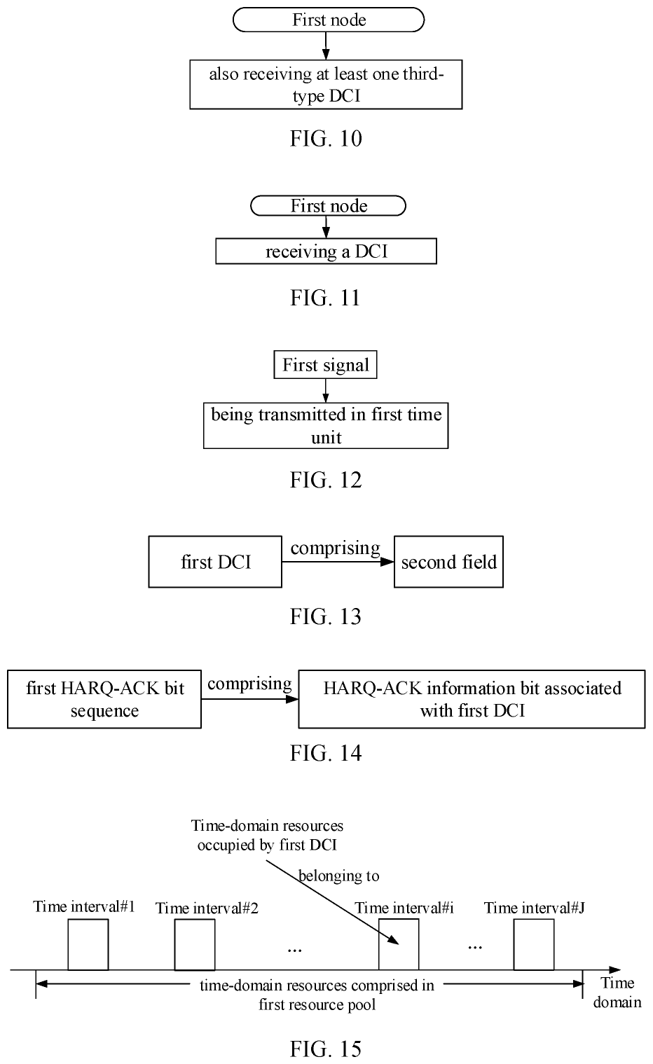

Embodiment 10 illustrates a flowchart of processing of a first node on a third-type DCI according to one embodiment of the present disclosure, as shown in FIG. 10. In case of no conflict, the characters of multiple subembodiments of Embodiment 10 can be arbitrarily combined.

In Embodiment 10, the first node in the present disclosure also receives at least one third-type DCI; herein, time-domain resources occupied by a said third-type DCI belong to a time interval before a time interval to which time-domain resources occupied by the first DCI in the present disclosure belong; the third-type DCI indicates the first time unit in the present disclosure; the third-type DCI is used for scheduling a PDSCH reception based on Transport Blocks (TBs), and a number of TB(s) carried by the TB-based PDSCH reception scheduled by the third-type DCI is no greater than K; value of the first field in the present disclosure which is comprised in the first DCI is unrelated to the third-type DCI.

In one subembodiment of Embodiment 10, in terms of time domain, the first resource pool comprises a time interval to which time-domain resources occupied by a said third-type DCI received by the first node belong.

In one subembodiment of Embodiment 10, value of the first field in the present disclosure which is comprised in the first DCI is unrelated to a number of pieces of the third-type DCI received by the first node.

In one embodiment, a said third-type DCI is a DCI format 1_0, for the specific definition of the DCI format 1_0, refer to 3GPP TS38.212, Chapter 7.3.1.2.

In one embodiment, a said third-type DCI is a DCI format 1_1, for the specific definition of the DCI format 1_1, refer to 3GPP TS38.212, Chapter 7.3.1.2.

In one embodiment, a said third-type DCI is a DCI format 1_2, for the specific definition of the DCI format 1_2, refer to 3GPP TS38.212, Chapter 7.3.1.2.

In one embodiment, a said third-type DCI is used to indicate Downlink Grant.

### Embodiment 11

Embodiment 11 illustrates a flowchart of processing of a first node on a DCI according to one embodiment of the present disclosure, as shown in FIG. 11. In case of no conflict, characters in multiple subembodiments of Embodiment 11 can be arbitrarily and mutually combined.

In Embodiment 11, the first node in the present disclosure receives a DCI; the DCI indicates a first time unit, and, a total number of TBs carried by a TB-based PDSCH reception scheduled by the DCI is greater than K1; a number of TBs carried by a TB-based PDSCH reception associated with the first time unit scheduled by the DCI is related to a total number of TBs carried by TB-based PDSCH receptions scheduled by the DCI.

In one subembodiment of the Embodiment 11, the DCI also indicates another time unit.

In one subembodiment of Embodiment 11, the number of the TBs carried by the TB-based PDSCH reception associated with the first time unit which is scheduled by the DCI is equal to: a result of the total number of the TBs carried by the TB-based PDSCH receptions scheduled by the DCI divided by 2 being rounded up or down to a nearest integer.

In one subembodiment of Embodiment 11, only when the number of the TBs carried by the TB-based PDSCH reception associated with the first time unit which is scheduled by the DCI is greater than K in the present disclosure: the DCI belongs to the first-type DCI in the present disclosure.

In one subembodiment of Embodiment 11, the DCI is the first DCI in the present disclosure.

In one subembodiment of Embodiment 11, the DCI is another DCI other than the first DCI in the present disclosure.

In one embodiment, when a DCI does not indicate a first time unit or a total number of TB(s) carried by a PDSCH reception based on TBs scheduled by the DCI is no greater than K1, the DCI does not belong to the first-type DCI in the present disclosure.

In one embodiment, when a DCI does not indicate a first time unit, the DCI does not belong to the first-type DCI in the present disclosure.

In one embodiment, when a DCI indicates a first time unit and a total number of TB(s) carried by a PDSCH reception based on TBs scheduled by the DCI is no greater than K1 but is greater than K, the DCI belongs to the first-type DCI in the present disclosure.

In one embodiment, when a DCI indicates a first time unit and a total number of TB(s) carried by a PDSCH reception based on TBs scheduled by the DCI is no greater than K in the present disclosure, the DCI belongs to the first-type DCI in the present disclosure.

In one embodiment, K1 is equal to 1.

In one embodiment, K1 is equal to 2.

In one embodiment, K1 is a positive integer.

In one embodiment, K1 is no greater than 8.

In one embodiment, K1 is no greater than 16.

In one embodiment, K1 is no greater than 1124.

In one embodiment, K1 is the K in the present disclosure.

In one embodiment, the K1 is configured by a higher layer signaling.

In one embodiment, the K1 is determined according to a higher layer signaling configuration.

In one embodiment, the K1 is default.

### Embodiment 12

Embodiment 12 illustrates a schematic diagram of the relation between a first signal and a first time unit according to one embodiment of the present disclosure, as shown in FIG. 12.

In Embodiment 12, in time domain, the first signal in the present disclosure is transmitted in a first time unit.

In one embodiment, the first time unit in the present disclosure comprises a slot.

In one embodiment, the first time unit in the present disclosure comprises a sub-slot.

In one embodiment, the first time unit in the present disclosure comprises at least one multicarrier symbol.

In one embodiment, the first time unit in the present disclosure comprises a time window (i.e., a span).

In one embodiment, the first time unit in the present disclosure is a slot.

In one embodiment, the first time unit in the present disclosure is a sub-slot.

In one embodiment, the first time unit in the present disclosure is a time window.

In one embodiment, a said time unit in the present disclosure comprises a slot.

In one embodiment, a said time unit in the present disclosure comprises a sub-slot.

In one embodiment, a said time unit in the present disclosure comprises a span.

In one embodiment, a said time unit in the present disclosure comprises at least one multicarrier symbol.

In one embodiment, a said time unit in the present disclosure is a slot.

In one embodiment, a said time unit in the present disclosure is a sub-slot.

In one embodiment, a said time unit in the present disclosure is a span.

In one embodiment, the first signal is transmitted on a PUCCH in the first time unit.

In one embodiment, the first signal is transmitted on a PUSCH in the first time unit.

### Embodiment 13

Embodiment 13 illustrates a schematic diagram of the relation between first DCI and a second field according to one embodiment of the present disclosure, as shown in FIG. 13.

In Embodiment 13, a first DCI comprises a second field; for the first DCI, the second field comprised is used to indicate an accumulated number of cells scheduled by a first-type DCI and a second-type DCI up to a current cell and the current time interval in a first time-frequency resource pool, where the current cell is a cell scheduled by the first DCI, and time-domain resources occupied by the first DCI belong to the current time interval.

In one embodiment, the accumulated number of the cells scheduled by the first-type DCI and by the second-type DCI in the first time-frequency resource pool up to the current cell and the current time interval is: an accumulated number of {serving cell, time interval}-pairs associated with either of the first-type DCI or the second-type DCI up to the current cell and the current time interval in the first time-frequency resource pool.

In one embodiment, the second field is an indication field.

In one embodiment, the second field is used for counting.

In one embodiment, the second field is a Downlink Assignment Indicator (DAT) field.

In one embodiment, the second field is a counter DAI field.

In one embodiment, the second field comprises 1 bit.

In one embodiment, the second field comprises 2 bits.

In one embodiment, the second field comprises 3 bits.

In one embodiment, the second field comprises 4 bits.

In one embodiment, the second field comprises no more than 32 bits.

In one embodiment, a value in the second field is 1 or 2.

In one embodiment, a value in the second field is one of 1, 2, 3 or 4.

In one embodiment, a value in the second field is one of 1, 2, 3, 4, 5, 6, 7 or 8.

In one embodiment, a value in the second field is one of 1, 2, 3, 4, 5, 6, 7, 8, 9, 10, 11, 12, 13, 14, 15 or 16.

In one embodiment, a value in the second field is one of 0, 1, 2 or 3.

In one embodiment, a value in the second field is one of 0 through 7.

In one embodiment, a position of the HARQ-ACK bit block associated with the first DCI in the first HARQ-ACK bit sequence is determined based on the second field comprised in the first DCI.

In one embodiment, the first time-frequency resource pool comprises the first resource pool in the present disclosure in time domain.

In one embodiment, the first time-frequency resource pool is the first resource pool in the present disclosure.

In one embodiment, a limited number of {serving cell, time interval}-pair(s) can be defined in the first time-frequency resource pool.

In one embodiment, at least one {serving cell, time interval}-pair can be defined in the first time-frequency resource pool.

In one embodiment, the first time-frequency resource pool comprises resources occupied by a limited number of {serving cell, time interval}-pair(s).

In one embodiment, the first time-frequency resource pool comprises resources occupied by at least one {serving cell, time interval}-pair.

In one embodiment, the first time-frequency resource pool comprises resources in two dimensions: time domain and frequency domain.

In one embodiment, the first-type DCI in the present disclosure comprises the second field.

In one embodiment, the second-type DCI in the present disclosure comprises the second field.

### Embodiment 14

Embodiment 14 illustrates a schematic diagram of the relation between a first HARQ-ACK bit sequence and a first DCI according to one embodiment of the present disclosure, as shown in FIG. 14.

In Embodiment 14, a first HARQ-ACK bit sequence comprises a HARQ-ACK information bit associated with first DCI.

In one embodiment, the first HARQ-ACK bit sequence comprises HARQ-ACK information bits.

In one embodiment, the first HARQ-ACK bit sequence comprises a positive integer number of bits.

In one embodiment, the first HARQ-ACK bit sequence comprises a positive integer number of ACKs or NACKs.

In one embodiment, the first HARQ-ACK bit sequence comprises all or part of a HARQ-ACK codebook (or a sub-codebook).

In one embodiment, the first HARQ-ACK bit sequence comprises a second HARQ-ACK sub-codebook.

In one embodiment, the first HARQ-ACK bit sequence belongs to a second HARQ-ACK sub-codebook.

In one embodiment, the second HARQ-ACK sub-codebook is a sub-codebook used for bearing HARQ-ACK information bits for CBG-based PDSCH receptions.

In one embodiment, the second HARQ-ACK sub-codebook is a sub-codebook used for bearing HARQ-ACK information bits for TB-based PDSCH receptions scheduled by the first-type DCI.

In one embodiment, the second HARQ-ACK sub-codebook comprises a positive integer number of information bits.

In one embodiment, the first HARQ-ACK bit sequence comprises a Type-2 HARQ-ACK codebook (or, sub-codebook).

In one embodiment, the first HARQ-ACK bit sequence belongs to a Type-2 HARQ-ACK codebook (or, sub-codebook).

In one embodiment, the first HARQ-ACK bit sequence is transmitted on a physical layer channel.

In one embodiment, the first HARQ-ACK bit sequence is transmitted on a PUCCH.

In one embodiment, the first HARQ-ACK bit sequence is transmitted on a PUSCH.

In one embodiment, the first HARQ-ACK bit sequence is transmitted in the first time unit in the present disclosure.

In one embodiment, the first HARQ-ACK bit sequence comprises one or more HARQ-ACK information bits associated with the first DCI.

In one embodiment, the first HARQ-ACK bit sequence comprises multiple HARQ-ACK information bits associated with the first DCI.

In one embodiment, the HARQ-ACK information bit(s) associated with the first DCI is(are): HARQ-ACK information bit(s) generated by TBs or a CBG carried by a PDSCH reception scheduled by the first DCI.

In one embodiment, the HARQ-ACK bit block in the present disclosure comprises a positive integer number of HARQ-ACK bit(s).

In one embodiment, the HARQ-ACK bit block in the present disclosure comprises a HARQ-ACK bit in the first HARQ-ACK bit sequence or a HARQ-ACK bit sub-sequence in the first HARQ-ACK bit sequence.

In one embodiment, a HARQ-ACK information bit associated with the first DCI indicates an ACK or a NACK.

In one embodiment, a HARQ-ACK bit block associated with the first DCI comprises: a HARQ-ACK bit indicating whether a PDSCH reception or an SPS PDSCH release indicated by the DCI in the first DCI group is or not correctly received.

In one embodiment, harq-ACK-SpatialBundlingPUCCH is not provided.

In one embodiment, harq-ACK-SpatialBundlingPUCCH is provided.

In one embodiment, value of a parameter maxNrofCodeWordsScheduledByDCI is configured to be 1 (or n1).

In one embodiment, value of at least one parameter maxNrofCodeWordsScheduledByDCI is configured to be 2 (or n2).

In one embodiment, the value of the first field comprised in the first DCI is used to determine the first HARQ-ACK bit sequence.

In one embodiment, the value of the first field comprised in the first DCI is used as an input to the first node in its procedure of determining the first HARQ-ACK bit sequence.

### Embodiment 15

Embodiment 15 illustrates a schematic diagram of the relations among a first resource pool, a time interval and a first DCI according to one embodiment of the present disclosure, as shown in FIG. 15. In FIG. 15, a blank box represents time-domain resources occupied by a time interval. When no conflict is incurred, the characters of multiple subembodiments of Embodiment 15 can be mutually and arbitrarily combined.

In Embodiment 15, a number of cell(s) scheduled by any DCI is equal to 1; a first resource pool comprises J time intervals in time domain: time interval #1, time interval #2 . . . , and time interval #J; time-domain resources occupied by a first DCI belong to time interval #i among the J time intervals; where i is no greater than J, both the i and the J are positive integers; an index for the time interval #1, an index for the time interval #2 . . . , and an index for the time interval #J are increasing in sequence; for any positive integer j no greater than the J, a number of first-type DCIs by which time-domain resources occupied belong to the time interval #j is equal to uj, where uj is equal to 0 or a positive integer; a number of second-type DCIs by which time-domain resources occupied belong to the time interval #j is equal to vj, where vj is equal to 0 or a positive integer.

In one subembodiment of Embodiment 15, for the first DCI, by which the first field comprised indicates a total number of cells scheduled by the first-type DCI and the second-type DCI up to a current time interval (that is, the time interval #i) in the first resource pool, which is equal to

$${{\sum }_{j = 1}}^{i} {u}_{j} + {v}_{j} .$$

In one subembodiment of Embodiment 15, an index for a time interval is a PDCCH monitoring occasion index.

In one subembodiment of Embodiment 15, a number of {serving cell, time interval}-pair(s) associated with a said first-type DCI and a said second-type DCI is equal to 1.

In one subembodiment of Embodiment 15, indexes corresponding to the J time intervals are determined according to an ascending order of start times for search space sets respectively associated with the J time intervals.

### Embodiment 16

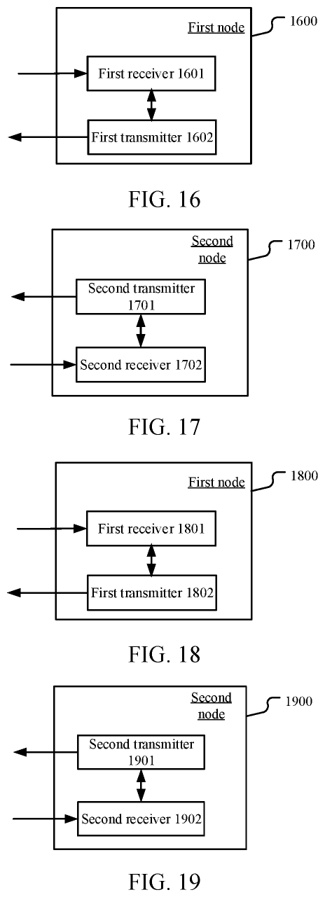

Embodiment 16 illustrates a structure block diagram of a processing device in a first node, as shown in FIG. 16. In FIG. 16, a first node processing device 1600 is comprised of a first receiver 1601 and a first transmitter 1602.

In one embodiment, the first node 1600 is a UE.

In one embodiment, the first node 1600 is a relay node.

In one embodiment, the first node 1600 is vehicle-mounted communication equipment.

In one embodiment, the first node 1600 is a UE supporting V2X communications.

In one embodiment, the first node 1600 is a relay node supporting V2X communications.

In one embodiment, the first receiver 1601 comprises at least one of the antenna 452, the receiver 454, the multi-antenna receiving processor 458, the receiving processor 456, the controller/processor 459, the memory 460 or the data source 467 in FIG. 4 of the present disclosure.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1601 comprises at least the first two of the antenna 452, the receiver 454, the multi-antenna receiving processor 458, the receiving processor 456, the controller/processor 459, the memory 460 and the data source 467 in FIG. 4 of the present disclosure.

In one embodiment, the first transmitter 1602 comprises at least one of the antenna 452, the transmitter 454, the multi-antenna transmitting processor 457, the transmitting processor 468, the controller/processor 459 the memory 460 or the data source 467 in FIG. 4 of the present disclosure.

In one embodiment, the first transmitter 1602 comprises at least the first five of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1602 comprises at least the first four of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1602 comprises at least the first three of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1602 comprises at least the first two of the antenna 452, the transmitter 454, the multi-antenna transmitting processor 457, the transmitting processor 468, the controller/processor 459 the memory 460 and the data source 467 in FIG. 4 of the present disclosure.

In Embodiment 16, the first receiver 1601 receives a first DCI; the first transmitter 1602 transmits a first signal, the first signal carrying a first HARQ-ACK bit sequence; herein, the first DCI comprises a first field; for the first DCI, the first field comprised is used for indicating a total number of cell(s) scheduled by first-type DCI(s) and cell(s) scheduled by second-type DCI(s) up to a current time interval in a first resource pool, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one embodiment, the first node U1 is configured with CBG-based PDSCH reception on at least one serving cell.

In one embodiment, the total number of the cells scheduled by the first-type DCI(s) and by the second-type DCI(s) in the first resource pool up to the current time interval is: a total number of {serving cell, time interval}-pair(s) associated with either of the first-type DCI(s) or the second-type DCI(s) up to the current time interval.

In one embodiment, the total number of the cells scheduled by the first-type DCI(s) and by the second-type DCI(s) in the first resource pool up to the current time interval is: a total number of {serving cell, time interval}-pair(s) associated with either of the first-type DCI(s) or the second-type DCI(s) up to the current time interval in a first resource pool.

In one embodiment, a number of TBs carried by a TB-based PDSCH reception associated with a first time unit which is scheduled by the first-type DCI is greater than K.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the first receiver 1601 receives on M PDSCHs; herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, when a number of TB(s) carried by a TB-based PDSCH reception scheduled by a DCI is no greater than K: the DCI does not belong to the first-type DCI.

In one embodiment, the first HARQ-ACK bit sequence comprises (a) HARQ-ACK information bit(s) associated with the first DCI.

In one embodiment, the first signal is transmitted in a first time unit.

### Embodiment 17

Embodiment 17 illustrates a structure block diagram a processing device in a second node according to one embodiment of the present disclosure, as shown in FIG. 17. In FIG. 17, a second node processing device 1700 is comprised of a second transmitter 1701 and a second receiver 1702.

In one embodiment, the second node 1700 is a UE.

In one embodiment, the second node 1700 is a base station.

In one embodiment, the second node 1700 is a relay node.

In one embodiment, the second node 1700 is vehicle-mounted communication equipment.

In one embodiment, the second node 1700 is UE supporting V2X communications.

In one embodiment, the second transmitter 1701 comprises at least one of the antenna 420, the transmitter 418, the multi-antenna transmitting processor 471, the transmitting processor 416, the controller/processor 475 or the memory 476 in FIG. 4 of the present disclosure.

In one embodiment, the second transmitter 1701 comprises at least the first five of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1701 comprises at least the first four of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1701 comprises at least the first three of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1701 comprises at least the first two of the antenna 420, the transmitter 418, the multi-antenna transmitting processor 471, the transmitting processor 416, the controller/processor 475 and the memory 476 in FIG. 4 of the present disclosure.

In one embodiment, the second receiver 1702 comprises at least one of the antenna 420, the receiver 418, the multi-antenna receiving processor 472, the receiving processor 470, the controller/processor 475 or the memory 476 in FIG. 4 of the present disclosure.

In one embodiment, the second receiver 1702 comprises at least the first five of the antenna 420, the receiver 418, the multi-antenna receiving processor 472, the receiving processor 470, the controller/processor 475 and the memory 476 in FIG. 4 of the present disclosure.

In one embodiment, the second receiver 1702 comprises at least the first four of the antenna 420, the receiver 418, the multi-antenna receiving processor 472, the receiving processor 470, the controller/processor 475 and the memory 476 in FIG. 4 of the present disclosure.

In one embodiment, the second receiver 1702 comprises at least the first three of the antenna 420, the receiver 418, the multi-antenna receiving processor 472, the receiving processor 470, the controller/processor 475 and the memory 476 in FIG. 4 of the present disclosure.

In one embodiment, the second receiver 1702 comprises at least the first two of the antenna 420, the receiver 418, the multi-antenna receiving processor 472, the receiving processor 470, the controller/processor 475 and the memory 476 in FIG. 4 of the present disclosure.

In Embodiment 17, the second transmitter 1701 transmits a first DCI; the second receiver 1702 receives a first signal, the first signal carrying a first HARQ-ACK bit sequence; herein, the first DCI comprises a first field; for the first DCI, the first field comprised is used for indicating a total number of cell(s) scheduled by first-type DCI(s) and cell(s) scheduled by second-type DCI(s) up to a current time interval in a first resource pool, time-domain resources occupied by the first DCI belonging to the current time interval; the first-type DCI is used for scheduling a PDSCH reception based on Transport Blocks (TBs), and a number of TBs carried by the TB-based PDSCH reception scheduled by the first-type DCI is greater than K, K being a positive integer; the second-type DCI is used for scheduling a PDSCH reception based on Code Block Groups (CBG).

In one embodiment, the second node is configured with CBG-based PDSCH reception on at least one serving cell for the first node in the present disclosure.

In one embodiment, the total number of the cells scheduled by the first-type DCI(s) and by the second-type DCI(s) in the first resource pool up to the current time interval is: a total number of {serving cell, time interval}-pains) associated with either of the first-type DCI(s) or the second-type DCI(s) up to the current time interval.

In one embodiment, the total number of the cells scheduled by the first-type DCI(s) and by the second-type DCI(s) in the first resource pool up to the current time interval is: a total number of {serving cell, time interval}-pains) associated with either of the first-type DCI(s) or the second-type DCI(s) up to the current time interval in a first resource pool.

In one embodiment, a number of TBs carried by a TB-based PDSCH reception associated with a first time unit which is scheduled by the first-type DCI is greater than K.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the second transmitter 1701 transmits on M PDSCHs; herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, when a number of TB(s) carried by a TB-based PDSCH reception scheduled by a DCI is no greater than K: the DCI does not belong to the first-type DCI.

In one embodiment, the first HARQ-ACK bit sequence comprises (a) HARQ-ACK information bit(s) associated with the first DCI.

In one embodiment, the first signal is received in a first time unit.

### Embodiment 18

Embodiment 18 illustrates a structure block diagram of a processing device in a first node, as shown in FIG. 18. In FIG. 18, a first node processing device 1800 is comprised of a first receiver 1801 and a first transmitter 1802.

In one embodiment, the first node 1800 is a UE.

In one embodiment, the first node 1800 is a relay node.

In one embodiment, the first node 1800 is vehicle-mounted communication equipment.

In one embodiment, the first node 1800 is a UE supporting V2X communications.

In one embodiment, the first node 1800 is a relay node supporting V2X communications.

In one embodiment, the first receiver 1801 comprises at least one of the antenna 452, the receiver 454, the multi-antenna receiving processor 458, the receiving processor 456, the controller/processor 459, the memory 460 or the data source 467 in FIG. 4 of the present disclosure.

In one embodiment, the first receiver 1801 comprises at least the first five of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1801 comprises at least the first four of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1801 comprises at least the first three of the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1801 comprises at least the first two of the antenna 452, the receiver 454, the multi-antenna receiving processor 458, the receiving processor 456, the controller/processor 459, the memory 460 and the data source 467 in FIG. 4 of the present disclosure.

In one embodiment, the first transmitter 1802 comprises at least one of the antenna 452, the transmitter 454, the multi-antenna transmitting processor 457, the transmitting processor 468, the controller/processor 459 the memory 460 or the data source 467 in FIG. 4 of the present disclosure.

In one embodiment, the first transmitter 1802 comprises at least the first five of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1802 comprises at least the first four of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1802 comprises at least the first three of the antenna 452, the transmitter 454, the multi-antenna transmitting processor 457, the transmitting processor 468, the controller/processor 459 the memory 460 and the data source 467 in FIG. 4 of the present disclosure.

In one embodiment, the first transmitter 1802 comprises at least the first two of the antenna 452, the transmitter 454, the multi-antenna transmitting processor 457, the transmitting processor 468, the controller/processor 459 the memory 460 and the data source 467 in FIG. 4 of the present disclosure.

In Embodiment 18, the first receiver 1801 receives a first DCI; the first transmitter 1802 transmits a first signal, the first signal carrying a first HARQ-ACK bit sequence; herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one embodiment, when a number of TB(s) carried by a TB-based PDSCH reception scheduled by a DCI is no greater than K: the DCI does not belong to the first-type DCI.

In one embodiment, the total number of the cells scheduled by the first-type DCI up to the current time interval in the first resource pool is: a total number of {serving cell, time interval}-pair(s) associated with first-type DCI(s) up to the current time interval.

In one embodiment, the total number of the cells scheduled by the first-type DCI up to the current time interval in the first resource pool is: a total number of {serving cell, time interval}-pair(s) being associated with the first-type DCI(s) in the first resource pool up to the current time interval.

In one embodiment, the total number of the cells scheduled by the first-type DCI up to the current time interval in the first resource pool is: a total number of {serving cell, time interval}-pair(s) being associated with the first-type DCI(s) in the first resource pool up to the current time interval according to a first ordering.

In one embodiment, a number of TBs carried by a TB-based PDSCH reception associated with a first time unit which is scheduled by the first-type DCI is greater than K.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the first signal is transmitted in a first time unit.

In one embodiment, the first receiver 1801 receives on M PDSCHs; herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, the first HARQ-ACK bit sequence comprises (a) HARQ-ACK information bit(s) associated with the first DCI.

In one embodiment, the value of the first field comprised in the first DCI is used to determine the first HARQ-ACK bit sequence.

### Embodiment 19

Embodiment 19 illustrates a structure block diagram a processing device in a second node according to one embodiment of the present disclosure, as shown in FIG. 19. In FIG. 19, a second node processing device 1900 is comprised of a second transmitter 1901 and a second receiver 1902.

In one embodiment, the second node 1900 is a UE.

In one embodiment, the second node 1900 is a base station.

In one embodiment, the second node 1900 is a relay node.

In one embodiment, the second node 1900 is vehicle-mounted communication equipment.

In one embodiment, the second node 1900 is UE supporting V2X communications.

In one embodiment, the second transmitter 1901 comprises at least one of the antenna 420, the transmitter 418, the multi-antenna transmitting processor 471, the transmitting processor 416, the controller/processor 475 or the memory 476 in FIG. 4 of the present disclosure.

In one embodiment, the second transmitter 1901 comprises at least the first five of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1901 comprises at least the first four of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1901 comprises at least the first three of the antenna 420, the transmitter 418, the multi-antenna transmitting processor 471, the transmitting processor 416, the controller/processor 475 and the memory 476 in FIG. 4 of the present disclosure.

In one embodiment, the second transmitter 1901 comprises at least the first two of the antenna 420, the transmitter 418, the multi-antenna transmitting processor 471, the transmitting processor 416, the controller/processor 475 and the memory 476 in FIG. 4 of the present disclosure.

In one embodiment, the second receiver 1902 comprises at least one of the antenna 420, the receiver 418, the multi-antenna receiving processor 472, the receiving processor 470, the controller/processor 475 or the memory 476 in FIG. 4 of the present disclosure.

In one embodiment, the second receiver 1902 comprises at least the first five of the antenna 420, the receiver 418, the multi-antenna receiving processor 472, the receiving processor 470, the controller/processor 475 and the memory 476 in FIG. 4 of the present disclosure.

In one embodiment, the second receiver 1902 comprises at least the first four of the antenna 420, the receiver 418, the multi-antenna receiving processor 472, the receiving processor 470, the controller/processor 475 and the memory 476 in FIG. 4 of the present disclosure.

In one embodiment, the second receiver 1902 comprises at least the first three of the antenna 420, the receiver 418, the multi-antenna receiving processor 472, the receiving processor 470, the controller/processor 475 and the memory 476 in FIG. 4 of the present disclosure.

In one embodiment, the second receiver 1902 comprises at least the first two of the antenna 420, the receiver 418, the multi-antenna receiving processor 472, the receiving processor 470, the controller/processor 475 and the memory 476 in FIG. 4 of the present disclosure.

In Embodiment 19, the second transmitter 1901 transmits a first DCI; the second receiver 1902 receives a first signal, the first signal carrying a first HARQ-ACK bit sequence; herein, the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; the first-type DCI is used for scheduling a TB-based PDSCH reception, and a number of TBs carried by the TB-based PDSCH reception scheduled by the first-type DCI is greater than K, K being a positive integer.

In one embodiment, when a number of TB(s) carried by a TB-based PDSCH reception scheduled by a DCI is no greater than K: the DCI does not belong to the first-type DCI.

In one embodiment, the total number of the cells scheduled by the first-type DCI up to the current time interval in the first resource pool is: a total number of {serving cell, time interval}-pair(s) associated with first-type DCI(s) up to the current time interval.

In one embodiment, the total number of the cells scheduled by the first-type DCI up to the current time interval in the first resource pool is: a total number of {serving cell, time interval}-pair(s) being associated with the first-type DCI(s) in the first resource pool up to the current time interval.

In one embodiment, the total number of the cells scheduled by the first-type DCI up to the current time interval in the first resource pool is: a total number of {serving cell, time interval}-pair(s) being associated with the first-type DCI(s) in the first resource pool up to the current time interval according to a first ordering.

In one embodiment, a number of TBs carried by a TB-based PDSCH reception associated with a first time unit which is scheduled by the first-type DCI is greater than K.

In one embodiment, a said first-type DCI is a DCI that fulfills either of two conditions: scheduling a TB-based PDSCH reception by which all TBs carried are associated with a first time unit; or, scheduling a TB-based PDSCH reception by which some of multiple TBs carried are associated with a first time unit, while others of the multiple TBs carried are associated with a time unit other than the first time unit.

In one embodiment, some of multiple TBs carried by a TB-based PDSCH reception scheduled by the first DCI are associated with a first time unit, while others of the multiple TBs carried by the TB-based PDSCH reception scheduled by the first DCI are associated with a time unit other than the first time unit.

In one embodiment, the first signal is transmitted in a first time unit.

In one embodiment, the second transmitter 1901 transmits on M PDSCHs; herein, the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

In one embodiment, the first HARQ-ACK bit sequence comprises (a) HARQ-ACK information bit(s) associated with the first DCI.

In one embodiment, the value of the first field comprised in the first DCI is used to determine the first HARQ-ACK bit sequence.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The first node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present disclosure includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving first DCI; and
a first transmitter, transmitting a first signal, the first signal carrying a first HARQ-ACK bit sequence;
wherein the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by TB-based PDSCH reception(s) scheduled by a DCI is no greater than K: the DCI does not belong to the first-type DCI.

2. The first node according to claim 1, wherein the first DCI belongs to the first-type DCI; the total number of the cell(s) scheduled by the first-type DCI(s) up to the current time interval in the first resource pool is: a total number of {serving cell, time interval}-pains) associated with first-type DCI(s) up to the current time interval.

3. The first node according to claim 2, comprising:
the first receiver, receiving on M PDSCHs;
wherein the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

4. The first node according to claim 2, wherein the first HARQ-ACK bit sequence comprises HARQ-ACK information bit(s) associated with the first DCI.

5. The first node according to claim 2, wherein K is equal to 1; the first HARQ-ACK bit sequence comprises HARQ-ACK information bit(s) associated with the first DCI.

6. The first node according to claim 5, wherein the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

7. The first node according to claim 5, wherein the first signal is transmitted in a first time unit, each said first-type DCI indicates a HARQ-ACK information transmission in the first time unit.

8. A second node for wireless communications, comprising:
a second transmitter, transmitting first DCI; and
a second receiver, receiving a first signal, the first signal carrying a first HARQ-ACK bit sequence;
wherein the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by TB-based PDSCH reception(s) scheduled by a DCI is no greater than K: the DCI does not belong to the first-type DCI.

9. The second node according to claim 8, wherein the first DCI belongs to the first-type DCI; the total number of the cell(s) scheduled by the first-type DCI(s) up to the current time interval in the first resource pool is: a total number of {serving cell, time interval}-pair(s) associated with first-type DCI(s) up to the current time interval.

10. The second node according to claim 9, comprising:
the second transmitter, transmitting on M PDSCHs;
wherein the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

11. The second node according to claim 9, wherein K is equal to 1; the first HARQ-ACK bit sequence comprises HARQ-ACK information bit(s) associated with the first DCI.

12. The second node according to claim 11, wherein the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

13. The second node according to claim 11, wherein the first signal is transmitted in a first time unit, each said first-type DCI indicates a HARQ-ACK information transmission in the first time unit.

14. A method in a first node for wireless communications, comprising:
receiving first DCI; and
transmitting a first signal, the first signal carrying a first HARQ-ACK bit sequence;
wherein the first DCI comprises a first field; for the first DCI, the first field comprised is used for indicating a total number of cell(s) scheduled by first-type DCI(s) up to a current time interval in a first resource pool, time-domain resources occupied by the first DCI belonging to the current time interval; a said first-type DCI is used for scheduling multiple PDSCH receptions based on Transport Blocks (TBs), and a total number of TBs carried by the multiple TB-based PDSCH receptions scheduled by the said first-type DCI is greater than K, K being a positive integer; when a total number of TB(s) carried by TB-based PDSCH reception(s) scheduled by a DCI is no greater than K: the DCI does not belong to the first-type DCI.

15. The method according to claim 14, wherein the first DCI belongs to the first-type DCI; the total number of the cell(s) scheduled by the first-type DCI(s) up to the current time interval in the first resource pool is: a total number of {serving cell, time interval}-pair(s) associated with first-type DCI(s) up to the current time interval.

16. The method according to claim 15, comprising:
receiving on M PDSCHs;
wherein the first DCI comprises configuration information for the M PDSCHs; the first DCI schedules TB-based M PDSCH receptions, and a total number of TBs carried by the M TB-based PDSCHs scheduled by the first DCI is greater than K; M is a positive integer greater than 1.

17. The method according to claim 15, wherein the first HARQ-ACK bit sequence comprises HARQ-ACK information bit(s) associated with the first DCI.

18. The method according to claim 15, wherein K is equal to 1; the first HARQ-ACK bit sequence comprises HARQ-ACK information bit(s) associated with the first DCI.

19. The method according to claim 18, wherein the first HARQ-ACK bit sequence comprises a second HARQ-ACK sub-codebook, the second HARQ-ACK sub-codebook being a sub-codebook used for bearing HARQ-ACK information bit(s) for TB-based PDSCH reception(s) scheduled by the first-type DCI(s).

20. The method according to claim 18, wherein the first signal is transmitted in a first time unit, each said first-type DCI indicates a HARQ-ACK information transmission in the first time unit.
